(19) United States
(12) Patent Application Publication
(10) Pub. No.: US 2010/0174653 A1
(43) Pub. Date: Jul. 8, 2010

(54) Secure method and device of financial transaction

(76) Inventors: WeiCheng Tian, ShangHai (CN); Yi Dong, Shanghai (CN)

Correspondence Address: DAVID AND RAYMOND PATENT FIRM, 108 N. YNEZ AVE., SUITE 128, MONTEREY PARK, CA, 91754, US

(21) Appl. No.: 12/319,551

(22) Filed: Jan. 7, 2009

(51) Int. Cl. G06Q 40/00; H04L 9/32

(52) U.S. Cl. 705/71; 705/44

(57) ABSTRACT

A secure method and device thereof is provided for financial transaction without being access of any personal and confidential transaction information by any unwanted party, which includes the following steps. Receive transaction information and personal information of a user in a secure financial transaction device. Encrypt the transaction information, the personal information and a secure PIN of the user in the device and transfer the encrypted transaction information, personal information and the secure PIN to a designate financial entity through the Internet. Verify a payment amount to a designated financial account with the financial entity. Receive a confirmation in the device for the transaction of the payment amount to the designated financial account, after the payment amount is transferred to the designated financial account from the financial entity, by the financial entity through the Internet.

### BACKGROUND OF THE PRESENT INVENTION

1. Field of Invention

The present invention relates to financial management and services in financial transaction, and more particularly to a secure method and system of financial transaction for mobile banking, multiple accounts management, financial transaction between banks, online transaction, financial transaction between a payer and one or more business providers, and etc., without being access of any personal and confidential transaction information by any unwanted party.

2. Description of Related Arts

In today's commercial world, financial transaction becomes an essential matter to everybody. We pay by credit cards every day. We also do financial transaction such as transferring funds between bank accounts, wiring money to others, visiting ATM machine for deposit, cashing and account transaction, online payment, and online multiple accounts management, online transaction, and etc., from time to time. Due to the fact that personal and transaction information of the card holder or the account owner are unavoidably transmit through the banking apparatus such as POS machine for credit card, ATM machine, and operation computer through Internet, such confidential information will be exposed to the public that may caused serious commercial frauds.

With the development of communication and computer technology, it is very convenient for the customers or corporations to utilize electronic devices such as ATM machines, POS machines and computers to conduct financial transactions or to manage bank accounts through the Internet. In fact, the more convenient it is to perform electronics transaction, the less secure the users' personal information is.

Generally speaking, there are three parties involved in an ordinary transaction activity, the payer, the receiver, and the financial organization. For example, during a purchase deal, the buyer needs to pay money to the seller using a credit card which is operated by a credit card company. At this circumstance, the buyer is the payer, the seller is the receiver, and the credit card company is the financial organization. During the payment activity, the buyer gives his/her credit card to the seller. Then the seller uses seller's POS machine to read/record the information which is stored on the credit card. After that, the seller communicates with the credit card company though the POS machine via a net work to verify the information and request a transaction. After receiving the card information and the request, the credit company then performs the transaction between the accounts of the buyer and the seller respectively.

During the payment activity, the biggest problem is the payer has to provide his credit card information to the receiver. Once this happened, the payer has no control of this information any more. The seller may use this information for criminal purpose intensively, or loss this information to others who may have criminal intention. Another problem is that, during the communication between the receiver and the financial organization, data is carried by open network such as the telephone wire and is possible to be caught for criminal intention.

In addition, when one hands his or her credit card to an employee of a service provider such as a store or a restaurant for payment, the card number, card owner name, expiration date, and even the card security code are all open to be accessed. You may trust the store but you may not want to trust its employee. It always has a risk that the one who serves you for the credit card payment may keep memory your card information and personal information (sometimes the employee may need to verify your personal ID with your credit card) and sell them to the credit card fraud party to illegally charge your credit card in other city or country. It is no more a secret technique for how to do data tamper and/or steal the card and personal information from the POS machine and the ATM machine. Your money in your account may be stolen by someone later when you scan your credit card, debit card or bank card every time.

Online banking is even more risky, hackers can easily hack your computer system to steal your personal and account information when you are using the Internet. Although firewalls are used, it is not news that the bank and government computer systems get hacked.

Currently, as more and more people start to shop online, the problem is more serious because the Internet is not a secure network. For an internet transaction, the payer still has to provide his sensitive information to the receiver whom the payer is not familiar with and may know nothing about. Also, the process of transmitting sensitive information through internet introduces more chances to expose this information to people with criminal intention.

Using traditional method of electronic transaction, there are two fundamental weaknesses. First, the payer has to disclose the sensitive information to the receiver without further control. Second, the transmission of this sensitive information among the payer, the receiver and the financial organization is not secured. It is a high desire to the market of developing a device and a method for performing electronic transaction without disclosing payer's sensitive information to uncontrolled parties, and also with secured transmission method to transmit sensitive information between the user and the financial organization.

The conventional processes of information collection and transmission have many security disadvantages. Firstly, all the data stored in many electronic devices are not well secured. For example, a portable POS machine stored all the credit card information which is generally protected by a four-digit password. It is very easy to be decoded through software or hardware. Secondly, many electronic devices are supporting the third party developed software. It is very convenient for the user to expend the device's function. But at the same time, many system resources are also opened to the third party developed software which could access sensitive information for criminal purposes. The best example is virus developed for personal computers. So a new method and a new electronic device for financial application must be developed fully consider the data security.

On the other hand, the information that inputted in the POS machine and the ATM machine for the transaction purpose may be illegally stolen by using any external forces or electronic devices to invade into the circuit board of the POS and ATM machines so as to obtain the information saved in the memory unit of the circuit board. Though those electronic devices provide an easier and more convenience way of life style, how to protect these important personal information from being illegally obtained for any illegal purposes is a main concern.

### SUMMARY OF THE PRESENT INVENTION

The invention is advantageous in that it provides a secure method and device for financial transaction without disclosing any sensitive information such as personal and account information to any uncontrolled or non-designated person or party.

Another advantage of the invention is to provide a secure transmission method and device for transmitting sensitive information between the user of the device and the financial entity.

Another advantage of the invention is to provide a secure method and device of financial transaction having been employing with the advance encryption technology for high strength anti-tamper and anti-filch for the PIN.

Another advantage of the invention is to provide a secure method and device of financial transaction for mobile banking, multiple accounts management, financial transaction between banks, online transaction, financial transaction between a payer and one or more business providers, and etc., without being access of any personal and confidential transaction information by any unwanted party.

Another advantage of the invention is to provide a secure method and device of financial transaction for one-to-one bank account connection by encrypted transmission technique.

Another advantage of the invention is to provide a secure method and device of financial transaction embedded a self-destroy arrangement to prevent data tamper.

Another advantage of the invention is to provide a secure method and device of financial transaction containing a security key inputting system employing a random PIN keypad generation technology.

Another advantage of the invention is to provide a secure method and device of financial transaction which employs a secure firmware for secure electronic transaction.

Another advantage of the invention is to provide a secure method and device of financial transaction having a key encryption system for guaranteeing a safety key storage for the encrypted information.

Another advantage of the invention is to provide a secure method and device of financial transaction which supports non-card transaction and checking.

Another advantage of the invention is to provide a secure method and device of financial transaction supporting electronic transaction between different banks.

Another advantage of the invention is to provide a secure method and device of financial transaction which enables entry without using PIN PAD and being anti-tamper and attack.

Another advantage of the invention is to provide a secure method and device of financial transaction for account information multiple authentications avoiding error transaction.

Another advantage of the invention is to provide a secure method and device of financial transaction with embedded security API, for supporting third-party re-development work, which is widely applied to highly secure online banking, B2B services, and large amount transactions on the Internet.

Another advantage of the invention is to provide a secure method and device of financial transaction adapted for multiple credit card management, multiple bank account management, transaction data export, data exchanging between two devices, and ATM interface software applied transaction.

Another advantage of the invention is to provide a secure method and device of financial transaction adapted for online shopping, online banking, online transaction, online financial management, and off-site and wireless payment.

Another advantage of the invention is to provide a secure method and device of financial transaction which improves operational privacy and safety of the banking customers, improves operational convenience of the banking customers, increases portfolio of the banks, has removed workload of the bank counters, decreases the labor cost of the banks, setups a convenient, effective, safety, reliable transaction tool and transaction platform for the global customers and banks.

Another advantage of the invention is to provide a secure method and device of financial transaction which is adapted for a card-to-card, account-to-account, card-to-account, account-to-card payment type, substituting the conventional payment methods of counter processing and online banking.

Another advantage of the invention is to provide a secure device of financial transaction which is provided with a triple-track magnetic card reader, an ICC reader and an ATM operating user interface, supporting the magnetic credit card standard and the international IC credit card standard. The device also has a full enclosure shell design and a digital dynamic keyboard model. The device can read and write directly with the LCD display.

Another advantage of the invention is to provide a secure device of financial transaction which is a hand-held device portable with fast financial transactions, USB connection, Bluetooth transmission, embedded software, and compatible with personal computers, notebooks, netbooks, PDAs, and mobile phones.

In accordance with another aspect of the invention, the present invention comprises a secure method of financial transaction, comprising the steps of:

(a) receiving transaction information and personal information of a user in a secure financial transaction device;

(b) encrypting the transaction information, the personal information and a secure PIN of the user in the device and transferring the encrypted transaction information, personal information and the secure PIN to a designate financial entity through the Internet;

(c) verifying a payment amount to a designated financial account with the financial entity; and

(d) receiving a confirmation in the device for the transaction of the payment amount to the designated financial account, after the payment amount is transferred to the designated financial account from the financial entity, by the financial entity through the Internet.

When the payment amount is supposed to be paid to the payment account of a service provider, the service provider will be confirmed by the bank of the payment account and/or the financial entity of the user of the payment. In other words, the user has no need to disclose any personal information and transaction information to the service provider.

In one embodiment of the present invention, the device employs an advance encryption technology for high strength anti-tamper and anti-filch for the PIN and a secure firmware for secure electronic transaction. The device also contains a self-destroy arrangement to prevent any data tamper wherein all the sensitive information such as the personal information, the transaction information and the entered PIN are permanently deleted in the device once the device detects any tamper.

In one embodiment of the present invention, the device also contains a security key inputting system that employs a random PIN keypad generation technology to ensure a confidential and secure transaction of the PIN. The device also contains a key encryption system for guaranteeing a safety key storage for the encrypted information.

Additional advantages and features of the invention will become apparent from the description which follows, and may be realized by means of the instrumentalities and combinations particular point out in the appended claims.

### BRIEF DESCRIPTION OF THE DRAWINGS

FIG. 1 is the flow chart illustrating the process of the application program requesting the firmware for system call according to a preferred embodiment of the present invention.

FIG. 2 is the flow chart illustrating the process of device power on according to the above preferred embodiment of the present invention.

FIG. 3 is the flow chart illustrating the process of system booting according to the above preferred embodiment of the present invention.

FIG. 4 is the flow chart illustrating the process of the firmware according to the above preferred embodiment of the present invention.

FIG. 5 is the flow chart illustrating the process of the firmware upgrading according to the above preferred embodiment of the present invention.

FIG. 6 is the flow chart illustrating the process of the application software upgrading according to the above preferred embodiment of the present invention.

FIG. 7 is the flow chart illustrating the process of the secure key loading according to the above preferred embodiment of the present invention.

FIG. 8 is a schematic view of a secure key system according to the above preferred embodiment of the present invention, illustrating the key pair generation system to the seed card and the transport cards.

FIG. 9 is a schematic view of the secure key system according to the above preferred embodiment of the present invention, illustrating the use of the transport card to synthesize the private key.

FIG. 10 is a schematic view of the seed card of the secure key system according to the above preferred embodiment of the present invention.

FIG. 11 is a schematic view of the transport card of the secure key system according to the above preferred embodiment of the present invention.

FIG. 12 is a schematic view of the target card as one of the transport cards of the secure key system according to the above preferred embodiment of the present invention.

FIG. 13 is a flow chart illustrating the key exporting from the seed card to the transport cards according to the above preferred embodiment of the present invention.

FIG. 14 is a flow chart illustrating the key synthesizing process according to the above preferred embodiment of the present invention.

FIG. 15 is a flow chart illustrating the key signature according to the above preferred embodiment of the present invention.

FIG. 16 is a block diagram illustrating the configuration of a touch screen device incorporating with a security key inputting system according to the above preferred embodiment of the present invention.

FIG. 17 illustrates an initial display of the touch screen panel according to the above preferred embodiment of the present invention.

FIG. 18 illustrates the re-location of the input characters on the touch screen panel according to the above preferred embodiment of the present invention.

FIGS. 19A and 19B illustrate an alternative mode of the activation key for the touch screen panel according to the above preferred embodiment of the present invention.

FIG. 20A is a sectional view of a securely data protecting arrangement of the electronic device according to the above preferred embodiment of the present invention.

FIG. 20B is a sectional view of a display module of the securely data protecting arrangement of the electronic device according to the above preferred embodiment of the present invention, illustrating a protection layer provided on a top surface of the display module.

FIG. 20C is a sectional view of a display module of the securely data protecting arrangement of the electronic device according to the above preferred embodiment of the present invention, illustrating the protection layer provided on a bottom surface of the display module.

FIG. 21 is an exploded view of the securely data protecting arrangement of the electronic device according to the above preferred embodiment of the present invention.

FIG. 22 is a partially enlarged view of a protection layer of the securely data protecting arrangement of the electronic device according to the above preferred embodiment of the present invention.

FIG. 23A is a perspective view of an outer casing incorporating with the securely data protecting arrangement of the electronic device according to the above preferred embodiment of the present invention.

FIG. 23B is a perspective exploded view of the outer casing incorporating with the securely data protecting arrangement of the electronic device according to the above preferred embodiment of the present invention.

FIG. 24 is a block diagram of a method of the securely data protecting arrangement of the electronic device according to the above preferred embodiment of the present invention.

FIG. 25 is a partially enlarged view of a protection layer of the securely data protecting arrangement of the electronic device according to a first alternative of the above preferred embodiment of the present invention.

FIG. 26 is a partially enlarged view of a protection layer of the securely data protecting arrangement of the electronic device according to a second alternative of the above preferred embodiment of the present invention.

### DETAILED DESCRIPTION OF THE PREFERRED EMBODIMENT

Referring to the drawings, a secure method and device of financial transaction according to a preferred embodiment of the present invention is illustrated. The secure financial transaction method of present invention comprises the steps of:

(a) receiving transaction information and personal information of a user in a secure financial transaction device;

(b) encrypting the transaction information, the personal information and a secure PIN of the user in the device and transferring the encrypted transaction information, personal information and the secure PIN to a designate financial entity through the Internet;

(c) verifying a payment amount to a designated financial account with the financial entity; and

(d) receiving a confirmation in the device for the transaction of the payment amount to the designated financial account, after the payment amount is transferred to the designated financial account from the financial entity, by the financial entity through the Internet.

When the payment amount is transferred from one financial account to another financial account of the user as the payment account, all the information to be transmitted is encrypted from hacking during the transaction through the Internet.

When the payment amount is supposed to be paid to the payment account of a service provider, the service provider will be confirmed by the bank of the payment account and/or the financial entity of the user of the payment. In other words, the user has no need to disclose any personal information and transaction information to the service provider.

The device employs an advance encryption technology for high strength anti-tamper and anti-filch for the PIN and a secure firmware for secure electronic transaction. The device also contains a self-destroy arrangement to prevent any data tamper wherein all the sensitive information such as the personal information, the transaction information and the entered PIN are permanently deleted in the device once the device detects any tamper.

The device also contains a security key inputting system that employs a random PIN keypad generation technology to ensure a confidential and secure transaction of the PIN. The device also contains a key encryption system for guaranteeing a safety key storage for the encrypted information.

In order to provide secure electronic transactions, the present invention provides a secure firmware for providing protection for transaction and a unified standard interface for application programs. The device of the present invention has a very high security request to execute a plurality of secure related processes, including secure key management, data encoding and decoding, sensitive data imputing, and sensitive device operation, which are all under control of the firmware.

In detail, the secure key/password management manages the working key and the transaction key. The working key comprises verification key for applications, and password for firmware setting. The transaction key comprises encoding key for secure key (KEK), encoding key for data (MACK), encoding key for PIN (PINK), and magnetic stripe card key (MAGK). The data encoding and decoding comprises DES encoding/decoding, and RSA encoding/decoding. The sensitive data inputting includes user's PIN inputting. The sensitive device operation comprises touch screen operation, LCD display, sensitive data accessing, and magnetic reader accessing.

Providing a unified standard interface for application programs is also for the purpose of security. The application programs can only use system call to access the services provided by the firmware, which avoids the direct access to system resources and increases the safety of the system. The firmware provides two main interfaces which are access to the physical device, and access to sensitive services interface. The physical device interfaces comprise USB related interfaces, serial port, LCD related interface, ICCARD related interface, MAGCARD related interface, DATAFLASH related interface, BEEP related interface, RTC related interface, key board related interface. The sensitive services interface comprises encoding/decoding service, key update service, PIN inputting, and device registration, etc.

The method of secure financial transaction of the present invention is realized through software and hardware. In a preferred embodiment of the present invention, the device comprises a central processing unit (CPU), the CPU also comprises a static random access memory (SRAM), a secure SRAM, and a memory management unit (MMU) integrated inside. The device also comprises a synchronous dynamic random access memory (SDRAM), and a NorFlash which are connected with the CPU as extend memories. The secure SRAM is used to store the secure keys, passwords, and other sensitive data. The secure SRAM will not lose the data when the power is off, and will erase the data when the hardware is being attached. The SRAM provides the memory space for the processing of the firmware. Since the SRAM is integrated inside the CPU chip, it avoids malicious reading by other applications. The extending SDRAM provides the memory space for application programs. The NorFlash is used for storing the code of the firmware and the application programs, as well as other data files, such as font and gallery.

The CPU is operating in two modes, i.e. the supervisor mode and the user mode. The supervisor mode can access all the resources within the CPU, but the user mode can not access the resources protect by the operation system. The MMU is used to isolate the user space and the firmware space. Through the configuration of the MMU, the application programs processing in the user space can not access the sensitive data and resources protected by the firmware. As a result, the sensitive data and services are protected, the transaction is secured.

The MMU realized the memory protection function, and maps the virtual address to the physical address. One important step of the present invention is utilizing the mapping function and access permission function with the MMU in the firmware. The firmware is processing under supervisor mode. The MMU is configured that, in supervisor mode, the entire memory space and resources are accessible; but in user mode, the SRAM in the CPU and the high address space which is the register space of the CPU are not accessible. The high address space of the CPU comprises the secure SRAM space for storing the secure key, passwords, and user's sensitive data. The SRAM is the space for running the firmware.

In this manner, even if the user's application program is modified unfriendly, for example, be hacked, the secure key, passwords, user's sensitive data, and the firmware's code and data are still not able to be read and written by the application program. So the data and the device are secured.

After the firmware actives the function of the MMU, the user's application program is running under user mode. The firmware takes over all the service functions at the bottom-layer, and provides interface functions for the application programs. For example, if the user's application program wants to send data through the serial port, it can not operate the register of the CPU directly because the access to the register is abandoned. The program can only use system call provided by the firmware code to send the data.

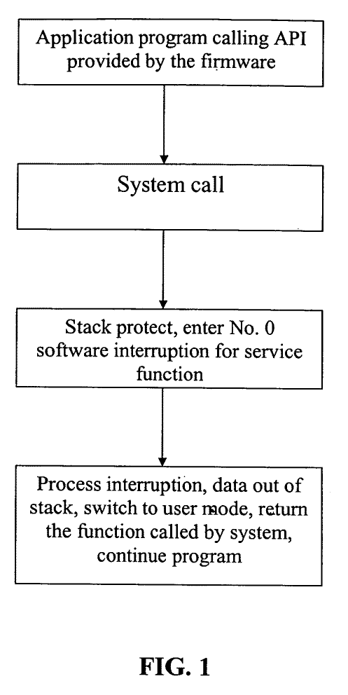

Under user mode, user's application program can not switch the working mode of the CPU, so the application program can not call the bottom-layers service functions directly. FIG. 1 illustrates the process of the application program to access firmware functions via system call, in other words, via software interruptions (SWI).

Referring to FIG. 1, the user application program will provide user different functions, but the realization of the function defends on the firmware. If the operation applied by the application program is not safe, for example, displaying the secure key on screen, but the firm wire doesn't have this function, the application of the function will not be performed. It is obvious that the firmware is managing the user's application program safely.

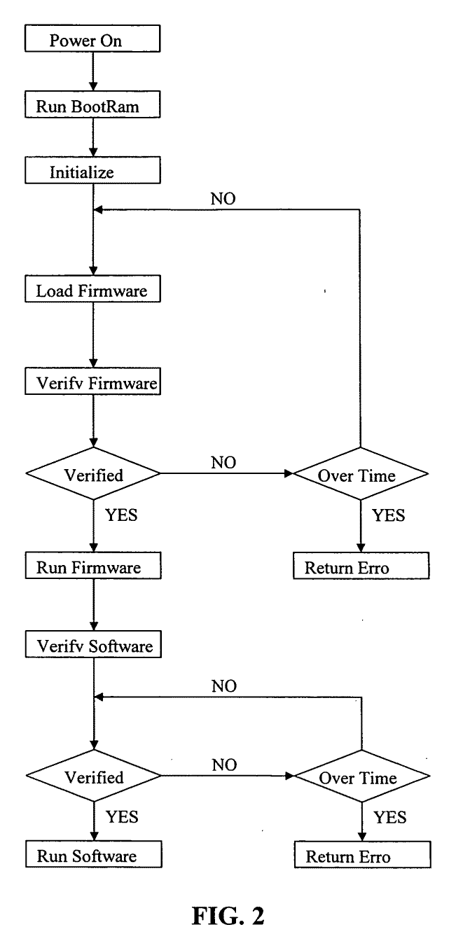

The program of the secure device comprises four components, namely BootRom, Firmware loader, Secure Firmware, and Application Program. Referring to FIG. 2, when the secure device is switched on, the system is powered on, the BootRom which is programmed in the inner ROM of the CPU is processed. The BootRom then locates the Firmware loader in the NorFlash, and loads it into the SRAM within the CPU. After verification, the Firmware loader will be processed if it is verified, otherwise it will not be processed and result as system error. The Firmware loader then initializes the registers of the CPU, configures the MMU, then locates the firmware in the NorFlash, and loads the firmware. After the loading of the firmware, the firmware will be verified. If it passes the verification, the firmware will be processed; otherwise, it will turn out to be system error. Once processed, the firmware calls the bottom-layer service functions to initialize the system, then locates the application program code in the NorFlash to load it into the external SDRAM, and verify the application program code. If the application program code is verified, it will be processed, otherwise, it will be system error.

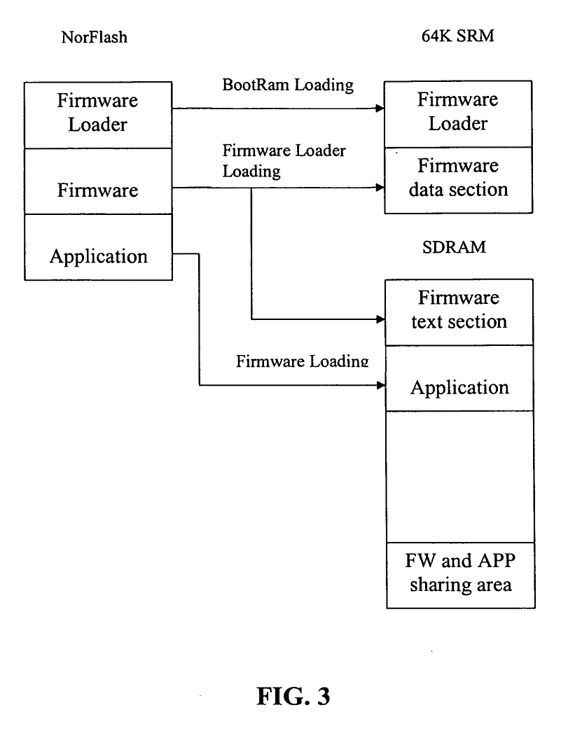

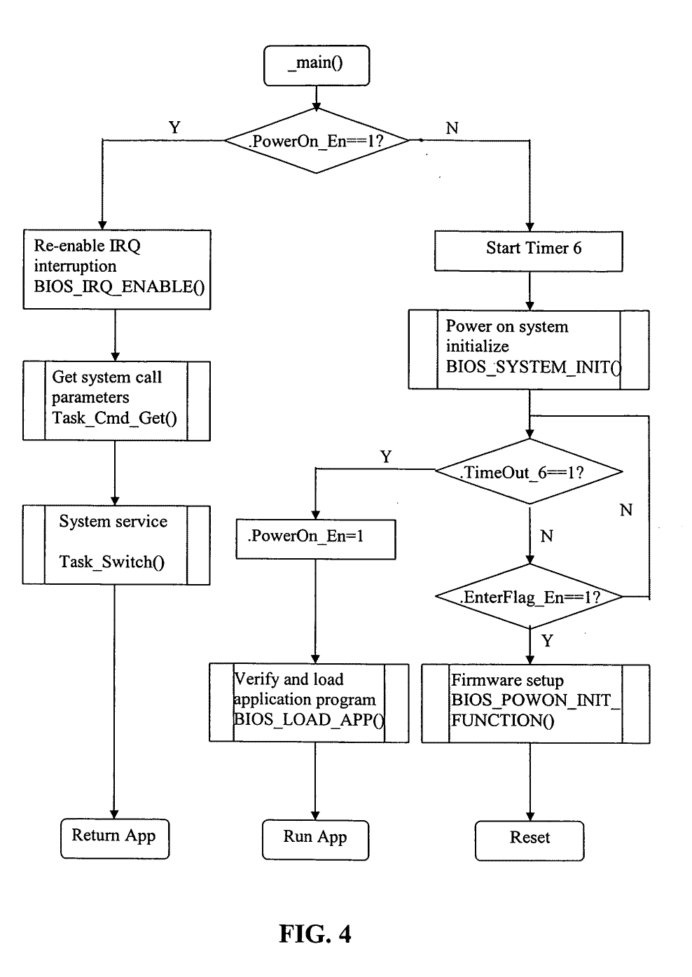

Referring to FIGS. 3 and 4, there are two cases to enter into the firmware space when every time the system is powered on and when the software interruption abnormal. Every time when the system is powered on, the device will verify. If it is the first time the device is switched on. If yes, the device will initialize the system password, using a random number generated by a random number generator to generate a secure key. At the same time, some system information and system status are saved.

If it is not the first time powered on, the system verifies if it is needed to set up the firmware. If not, the code of the firmware verifies the necessary fond and gallery, and then process the verification of the application program which is mentioned before.

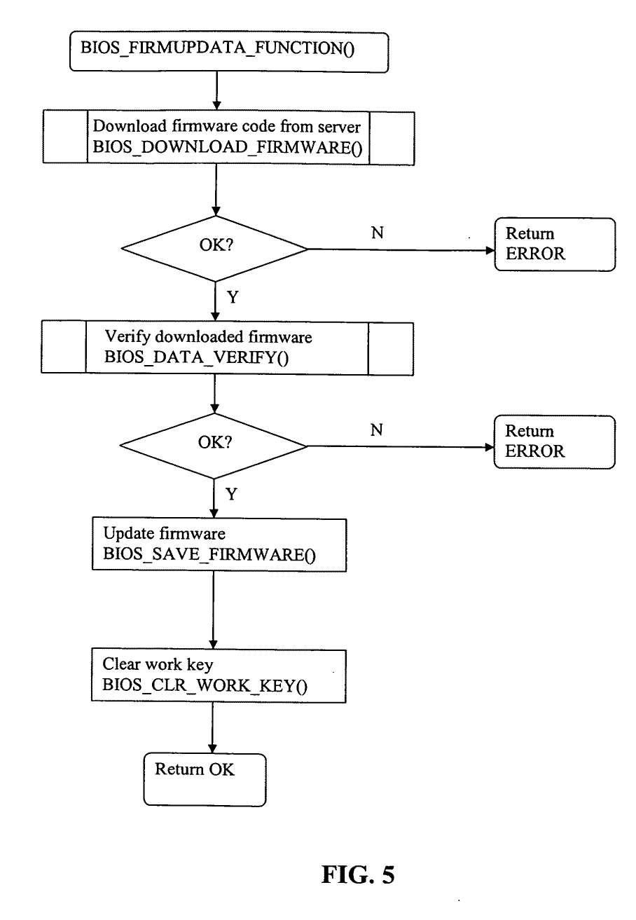

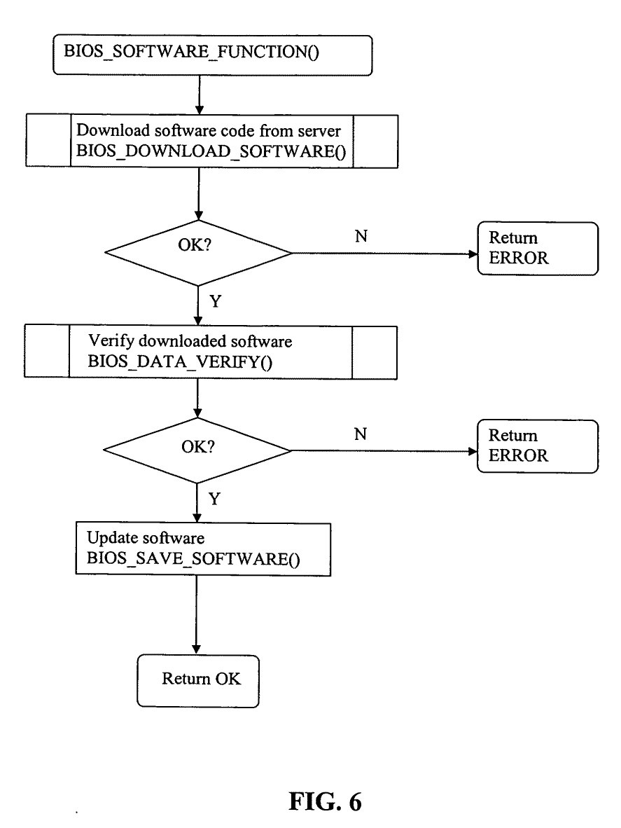

Referring to FIG. 5, if it is needed to reset the firmware, it enters into the system log in interface and a system password is needed to input. The firmware sends the device information and status to its higher lever server and waits for the response to verify if it is necessary to enter into hardware upgrade, software upgrade, and secure key loading interface; otherwise it will enter into password and clock setting interface.

If the firmware space is entered because the system is called by the software interruption, the firmware reads the related data from the memory which is shared with the application program, analyze and verify this related data. If the data is verified, the firmware calls the system function in the firmware code. The system function then calls the required bottom-layer services to perform the function. After that, the system switches back to user mode and return.

Referring to FIG. 5, during firmware upgrading process, when the system is powered on, the user can decide to enter into firmware setup window. If it is selected and the password is verified, the setup window is entered. The setup window provides the function of upgrading firmware and application program, loading secure key, and the function of modifying the firmware parameters.

For upgrading firmware and application program, the firmware first sends the related information to the server, preferably via USB port. If the server is the setup server and allows the firmware to upgrade, it sends the relative command to the device processing the firmware for upgrading. Then the firmware downloads the upgrading data to the external SDRAM. After downloading, the firmware verifies the digital signature. If the digital signature is verified, the upgrade is performed. If the upgrading is for the firmware, after the upgrading, the original transaction secure key is cleared. The setup window provides a device interface to set the firmware password and clock.

According to the preferred embodiment of the present invention, the firmware provides a unified standard interface for application program development. The application program can only use system call to realize user's applications. This avoids the direct accessing of system resources and increases the security. Also, this interface is dedicated for special utilization, software developed for personal computers cannot be processed on this firmware, so the virus for PC can not affect the firmware.

For security purpose, the firmware sets limitation to the application programs. For example, when the user is encoding/decoding data, the application program can only use the encoding/decoding interface provided by the firmware to realize the function, and cannot access the secure key data directly. Also, the firmware will never return the secure key data to an application program that it only returns the data which is encoded/decoded. For example, the application program must call firmware's interface to ask user to input PIN number. Then the firmware collects the PIN number and encodes the PIN number with a secure key PINK. After that, the firmware returns the encoded number to the application program. The application program will never know the PIN number.

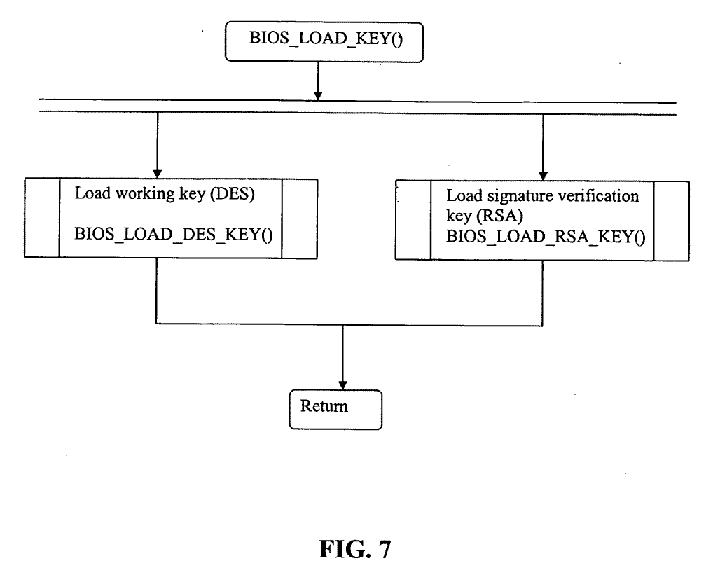

Referring to FIG. 7, the firmware needs load secure keys from the server. The firmware loads public key from the server directly. But the working key is very sensitive, the firmware uses distributed loading method to load working key.

The firmware also limits the application program to input to the LCD. The firmware prohibits the application program to display sensitive data, such as PIN, password, on the LCD. All the information displayed needs to be verified by the firmware.

The firmware also limits the application program to call sensitive services in time and frequency. For example, the frequency of the application program to call encoding/decoding service is limited in 10 times per minute. The firmware provides a real random input keyboard to avoid the inputted information being detected. The firmware also provides a debug interface to benefit application software development. The firmware provides a file access interface for the application program to access memories such as Flash to increase the efficiency of software development. The firmware provides a registration interface for message and user's buffer, to provide communication channel for the application program and the firmware.

On the other hand, key management is one of key issues in the field of information encryption. Accordingly, the key management generally consists of public key and private key. If the private key is deciphered, the information encrypted with the key management will be disclosed. In other words, the first issue of protecting the encrypted information through the key management is how to safely generate the private key. The second issue is how to safely store the private key in a key device. The third issue is how to protect the private key in the key device without being hacked.

In order to guarantee the safety of key storage for the encrypted information and ensure the transport card with the encrypted information not being hacked, the preferred embodiment of the present invention provides a secure key system by using a smart card as a security module.

The private key is decentralized and stored to the transport cards. Accordingly, the encryption algorithm, XOR encryption, and random number are used for the private key exporting and synthesizing processes. In addition, during the use of the private key, passwords, including PINm and PINu, must be inputted in order for the access of the private key. The transport cards are held by authorized people respectively. Therefore, the above mentioned preservations enhance the high security level of the secure key system of the present invention for preventing the private key from being deciphered.

The secure key system according to the preferred embodiment of the present invention utilizes the algorithm of RSA with 2048 bit, which consists of a public key and a private key. The secure key system for completing a confirmation process comprises a key provider for partitioning the private key generated by a key generation system and a plurality of key holder for holding the private key which is encrypted and decentralized from the key provider. Accordingly, all of the key holders are united to synthesize back the private key from the key components in order for completing the confirmation process so as to ensure the confirmation process being verified by all of the key holders.

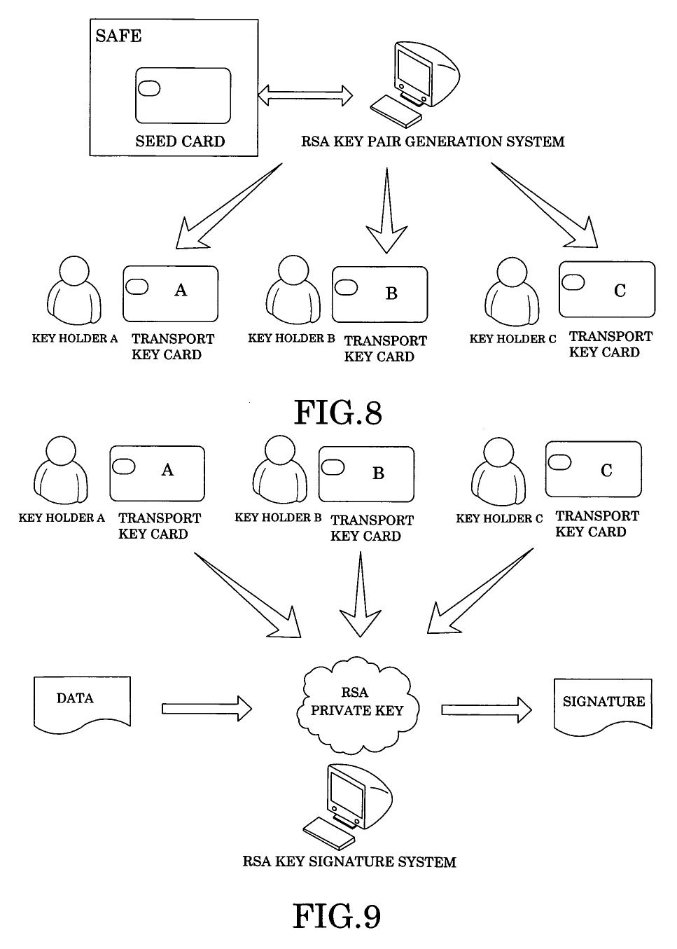

The secure key system uses a smart card which comprises a seed card as the key provider and at least two transport cards as the key holders. Preferably, there are two to five transport cards being used. According to the preferred embodiment, three transport cards are used. The private key is saved in the seed card. In addition, through the seed card, the private key is divided into three key components as the puzzles of the private key and saved into the three transport cards respectively, wherein the three transport cards are held by different authorized persons as the card holders, as shown in FIG. 8.

In other words, the seed card is used to transitionally save the private key and to initialize the key components to be saved in the key holders respectively. It is worth mentioning that the key provider and the key holders can be an electronic communicating device adapted to partition and encrypt the key components and to synthesize back the key components to the private key. Preferably, the key holders are the transport cards that the authorized persons can physically hold the transport cards in a security manner.

After the verification of each of the card holders, the key components in the transport cards can be synthesized back to form the private key. In other words, the private key will be achieved only, as shown in FIG. 9, when all the card holders represent the transport cards in order for performing the signature process as one example of the confirmation process. It is worth mentioning that during the synthesizing process of the private key, the private key will not be exported to any external device. The private key will only saved in a safety region of the smart card.

According to the preferred embodiment, the seed card and the transport cards of the smart card are JavaCard. The secure key system has a specific processor for RSA computation and specific security mechanism for key storage. Therefore, the private key can be saved in the smart card in a security manner.

Accordingly, each of the smart cards, including the seed card and the transport cards, has a serial number (SN) for regional identification. In addition, each smart card further has a set of Personal Identification Numbers (PIN), wherein the PIN consists of Personal Identification Number for Management (PINm) and Personal Identification Number for User (PINu). For exporting the private key and signature processing, the PINm and PINu must be inputted. Each of the smart cards also has its paired key, i.e. Transport Public Key (TKp) and Transport Private Key (TKs), and the security protection for corresponding data transmission.

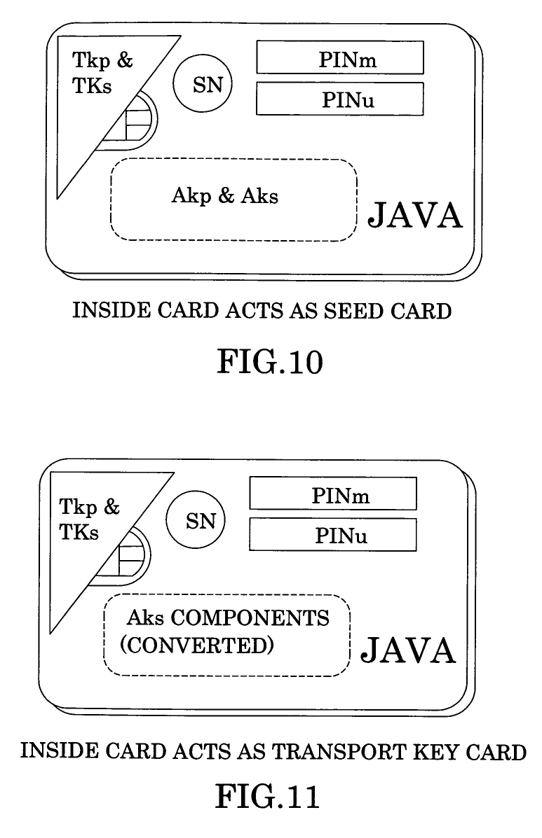

In particularly, after the generation of the private key through the key generation system, the private key is saved in the seed card. The seed card has a paired key, i.e. Application Public Key (AKp) and Application Private Key (AKs), wherein AKp and AKs are encrypted through RSA process, as shown in FIG. 10. In addition, Aks of the private key is used for number signature process while the public key submission is used for signature verification.

As shown in FIG. 11, each of the transport cards contains an encrypted key component as a part of the private key. The secure key system, which is also a key encryption signature system, will designate one of the transport cards as a target card for synthesizing the private key. After the signature process, the synthesized private key in the target card will be destroyed.

In order to generate the key through the key generation system, the private key has the AKs for the private key and AKp for the public key. The AKp of the public key is saved in the data or information. The AKs of the private key is saved in the safety region of the smart card, wherein the AKs is divided into a plurality of key components, as the AKs components. Preferably five key components are used in this embodiment for the AKs, i.e. p, q, dp, dq, and pq. It is worth mentioning that the key components of the private key can only be accessed after the verification, wherein they cannot be read or exported.

After the private key is generated, the seed card can be destroyed immediately or can be kept by the authorized person in a safety manner.

In particularly, the private key is generated through a key generation software, as an example, wherein the key generation software is a public software that it can be downloaded or purchased by a software provider.

However, the key generation system for the smart card, the data transmission of the smart card, and the use of the smart card are controlled and processed by a smart card software. The smart card software is private and secure.

Accordingly, the private key is generated and saved in the seed card through the smart card software. The private key is generated in responsive to AKp and AKs of the paired key. Then, the seed card transmits and decentralizes the AKs into different key components, i.e., for example, p, q, dp, dq, and pq. It is worth mentioning that AKp can be disclosed to the public. However, AKs cannot be disclosed to the public, wherein AKs is saved into two to five different transport cards.

Preferably, five different transport cards are used for saving five key components of AKs respectively. It is appreciated that two or more transport cards can also be used for saving the key components of AKs. It would be nonsense to save all the key components of AKs into one transport card.

It is worth mentioning that the key generation process for generating the key is not the subject matter of the present invention because there are many existing processes adapted to generate the key. However, how to securely save the key and how to protect the key are the subject matters of the present invention in order to prevent the leak of the key after the key is generated.

The key components of the private key to be exported to the transport cards in responsive to the key generation system depend on the number of the transport cards. TKp of the transport card is used for data transmission in a secure manner so as to verify the legality of the imported date to the transport card.

Accordingly, the export of the private key must require a random number so that the private key cannot be duplicated or reproduced. Every time after the AKs is exported to the transport card, the random number will be renewed.

The export of the key components of the private key is used by the algorithm of XOR (⊕), wherein the five key components of the private key and the random number are also generated in the seed card.

The conversion of the private key is used for linking one of the key components with the rest key components. For safety purpose, the random number is used during the conversion so as to ensure the different conversion values being formed for every conversion.

Accordingly, the following conversion process is illustrated.

H=p⊕q⊕dp⊕dq⊕pq⊕RND

CP (converted component p)=p⊕H;

CQ (converted component q)=q⊕H;

CDP (converted component dp)=dp⊕H;

CDQ (converted component dq)=dq⊕H;

CPQ (converted component pq)=pq⊕H;

CRND (converted component RND)=RND⊕H;

It is worth mentioning that the date imported into each of the transport cards must be encrypted as CP, CQ, CDP, CDQ, CPQ, and CRND. In addition, the key components of the private key after conversion are saved in the safety regions of the different transport cards and are unable to be read directly.

In order to synthesize the private key from the key components, every transport cards must be utilized. Before the use of the transport card, the respective card holder must input PINm of the corresponding transport card.

For safety purpose, the synthesized private key is preferred to be saved in one of the transport card, i.e. the target card. In other words, one of the transport cards must be designated as the target card as it is mentioned above. Preferably, all the transport cards have the same priority.

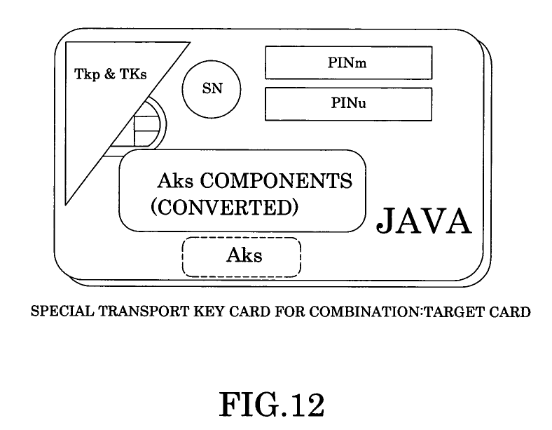

TKp at the target card ensures the data transmission to be secured and confirmed. In addition, the encrypted TKp at the target card is not part of the private key but is the key component of the private key after conversion. The key components of the private key are converted from the seed card and are exported to the transport cards. Therefore, the synthesized private key will be formed at the target card, as shown in FIG. 12.

After the signature process is completed, AKs of the private key in the target card will be erased or destroyed immediately. All the transport cards will then be reset to the original setting. Therefore, all the transport cards will be ready for the next signature process.

In order to convert the key components of the private key with the true value, the algorithm of XOR (⊕) is used as the following.

If H=CP⊕CQ⊕CDP⊕CDQ⊕CPQ⊕CRND; then:
p=CP⊕H;
q=CQ⊕H;
dp=CDP⊕H;
dq=CDQ⊕H;
pq=CPQ⊕H;

The key components of the private key will be completed by the reduction process in the target card.

The synthesizing process of the private key is illustrated as follows. Though the computation, CP, CQ, CDP, CDQ, and CPQ in the transport cards will be converted to p, q, dp, dq, and pq respectively. In addition, p, q, dp, dq, and pq will be saved in the target card.

AKs of the private key, including p, q, dp, dq, and pq, are saved in the target card to synthesize the private key thereat. Once the private key is accessed, i.e. once the signature process is completed, the private key will be destroyed by the software.

After the private key is used, all the transport cards will be reset back to the original setting. In other words, each transport card will contain the same setting of the key component.

The synthesizing process is repeatable. In other words, in order to complete the next signature process, all the transport cards must be re-used for synthesizing the private key.

The private key is formed by the synthesizing process through the algorithm of RSA, XOR, and random number to enhance the security level of the private key.

After the private key is generated at the seed card, the key components of the private key are exported to the transport cards respectively. Then, the seed card can be destroyed. If the seed card and all the transport cards are destroyed, the private key should be correspondingly lost.

Accordingly, the key encryption method for completing the confirmation process, comprises the following steps.

(1) Partition the private key into a plurality of key components.

(2) Convert the key components.

(3) After the key components are converted, export the key components into the key holders respectively for enhancing the security level of the private key.

(4) Synthesize back the private key by uniting the key components in the key holders in order for completing the confirmation process so as to ensure the confirmation process being verified by all of the key holders.

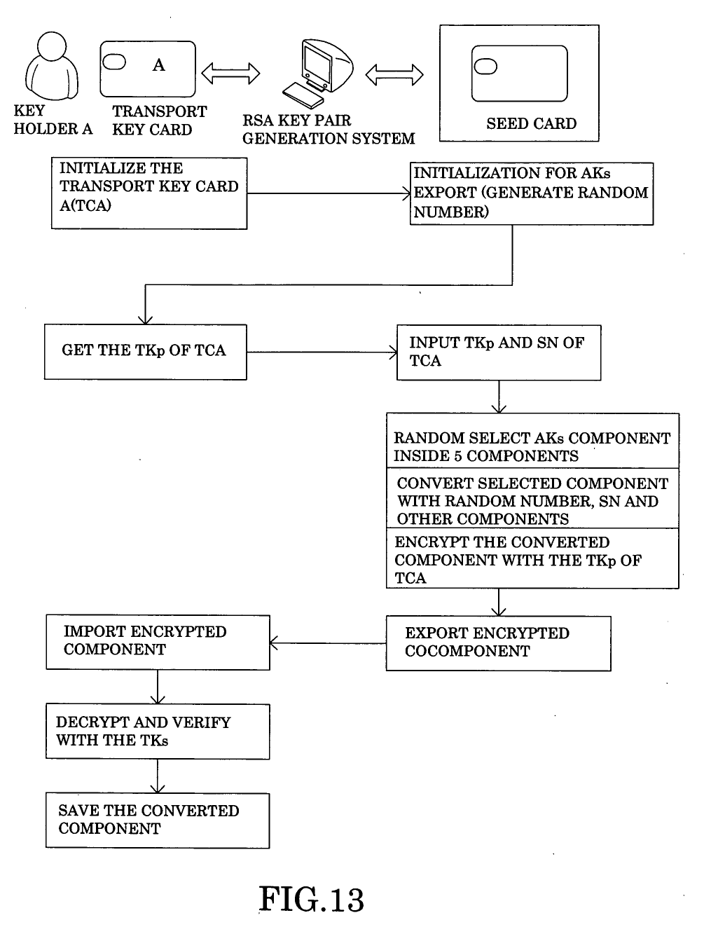

Accordingly, the steps (1) and (2) are the key export from the seed card to the transport cards. FIG. 13 illustrates flow diagram of the key exporting to the transport cards. As shown in FIG. 13, the seed card is arranged to initialize the transport card, as illustrated as the transport card A (TCA), wherein the seed card will generate the random number for the initialization of the AKs export. Meanwhile, the seed card will get the Transport Public Key (TKp) and Transport Private Key (TKs) as well as its serial number (SN). Accordingly, the seed card will get the TKp of the transport card A (TCA). In other words, by inputting the TKP and SN of the transport card A (TCA), the seed card will automatically identify the transport card A (TCA) to export the key components thereto.

In the step (1), the method of the present invention further comprises a step of selecting the number of the key components to be partitioned from the private key. Accordingly, the number of said key components correspondingly matches with the number of said key holders. When five transport cards are selected as in this embodiment, five key components are correspondingly formed. Once the number of the key components is selected, the seed card converts all the key components with the random number, serial number (SN), and other corresponding components, as shown in the step (2). After the conversion in the step (2), the method further comprises a step of encrypting the key components after the key components are converted and before the key components are exported to the key holders respectively. In other words, the seed card will encrypt the converted components with the TKp of transport card A (TCA). Once the encrypted components are completed, the encrypted components are ready to export to the transport card A (TCA).

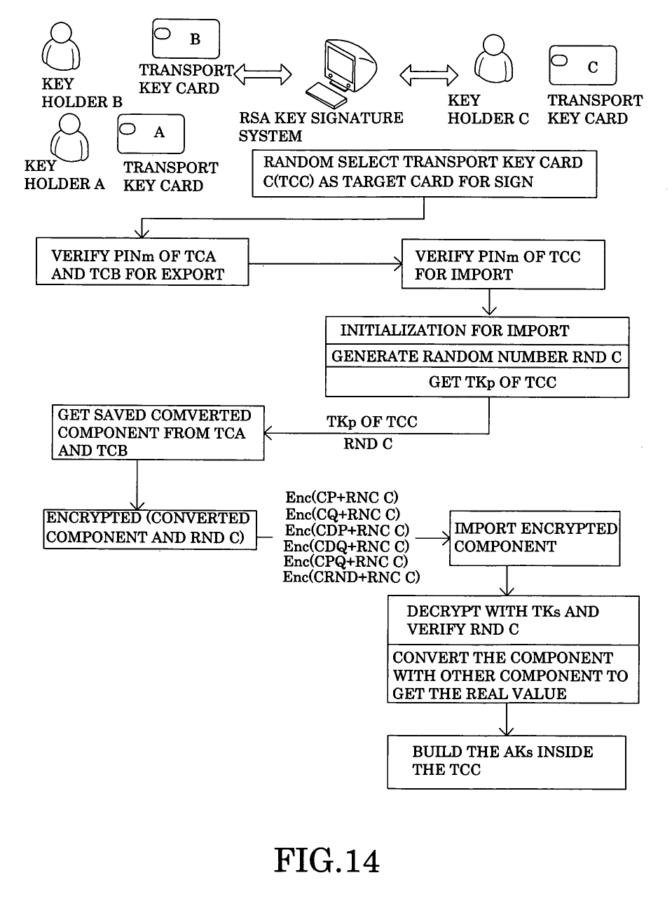

As shown in FIG. 14, the transport card C (TCC) is designated as the target card. It is worth mentioning that the target card can be designated by the operator or can be randomly picked by the seed card. Accordingly, when the transport card C (TCC) is utilized for synthesizing the private key, PINm of transport card A (TCC) and transport card B (TCB) are verified for export thereto. Meanwhile, PINm of transport card C (TCC) is also verified for import from the seed card. Once the steps of initialization for import of the transport card C (TCC) and generation of random number RND_C for the transport card C (TCC), and obtain TKp of transport card C (TCC), all the converted components from the transport card A (TCA) and the transport card B (TCB) are saved in the transport card C (TCC). Then, TKs of the transport card A (TCA), the transport card B (TCB), and the transport card C (TCC) are decrypted and the random number RND_C is verified, all the key components are converted to get the real value of the private key. Then, AKs will be built inside the transport card C (TCC).

Accordingly, all the transport cards (TCA), (TCB), (TCC) have the same level of priority. Alternatively, each transport card can have different priority levels that the transport cards (TCA), (TCB), (TCC) must be united in a predetermined manner. For example, the transport card A (TCA) must be used firstly to get the corresponding key component and the transport card B (TCB) must be used secondly to get the corresponding key component. Lastly, the transport card C (TCC) will be used as the target to get all the key components from the transport card A (TCA), the transport card B (TCB), itself. Furthermore, a time setting can be selectively preset from the seed card to the transport cards. For example, all the transport cards must be united at the same time or within a predetermined time range in order to combine the key components from all the transport cards for completing the signature process. Otherwise, the synthesizing process of the private key from the key component will be failed for the signature process.

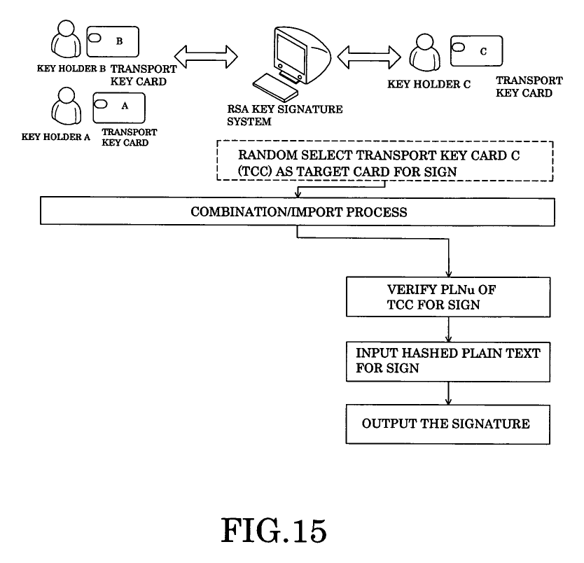

As shown in FIG. 15, the private key is synthesized in the transport card (TCC), i.e. the target card, through the combination/import process of the transport card A (TCA), the transport card B (TCB), and the transport card C (TCC). PINu of the transport card C (TCC) is required for verification in order to complete the signature process. Then, the user is able to input hashed plain text for sign and the signature will be output.

Accordingly, RSA algorithm is the most widely used public key algorithm, invented by Rivest, Shamir, and Adleman in 1977. it is based on a very simple number theory for the multiplication of two prime numbers to form a multiplication result. However, it is very difficult to decompose back to the prime numbers. Thus, multiplication result can be made public and can be used as the key encryption. However, the multiplication result can be simply restored back to the prime numbers. The multiplication result must be decrypted in order to form back the prime numbers. In other words, RSA algorithm provides a simple form to achieve a very reliable cryptosystem.

The following is an example of 2048 bit of RSA algorithm.

n is set as the key module, which is open to the public.

e is known as the key component of the public key, which is open to the public.

d is set as the key component of the private key, which is kept in secret.

(p, q, dp, dq, pq) is equivalent to d, which is kept in secret, wherein d is formed as the substitution of (p, q, dp, dq, pq) for enhancing the computing speed.

The key component of the present invention is d being partitioned from the private key.

```
{ /* Key number - 001 */
  { /* length in bits */
    2048
  },
  { /* Modulus - n */
    0xC3, 0x09, 0x58, 0x86, 0xAB, 0x6F, 0x65, 0x5A, 0xB7, 0x67, 0x71, 0x13, 0x0D, 0xAD, 0x79, 0x1C,
    0x4B, 0x07, 0x4A, 0xD6, 0x40, 0xB5, 0x58, 0x07, 0xBD, 0xFA, 0x8D, 0x15, 0x8D, 0x97, 0x27, 0xC5,
    0x0E, 0x6D, 0x88, 0x4D, 0xDE, 0x0C, 0xBB, 0x00, 0xC7, 0xD3, 0x95, 0xE8, 0x7F, 0x2F, 0x97, 0x65,
    0x4B, 0x39, 0xAC, 0x76, 0xDC, 0x2A, 0x27, 0x3D, 0xB5, 0x89, 0x96, 0xF7, 0x80, 0x38, 0x45, 0x15,
    0xB3, 0x4A, 0x0A, 0x25, 0xC4, 0x42, 0x64, 0xAA, 0x4D, 0x19, 0x32, 0xA3, 0x30, 0x17, 0x02, 0x00,
    0x5C, 0xB0, 0x78, 0xED, 0xD4, 0xEB, 0x95, 0x72, 0xA1, 0x0F, 0xA7, 0xB7, 0xAC, 0xF1, 0xB6, 0x9C,
    0xE2, 0x12, 0x21, 0x1A, 0x0D, 0x83, 0xC2, 0xE6, 0xA5, 0x3D, 0xEB, 0x6C, 0x28, 0x71, 0x06, 0xB5,
    0xD3, 0x2F, 0xC9, 0x84, 0x1D, 0xC9, 0x97, 0xD2, 0xDD, 0x48, 0xF4, 0x66, 0xE4, 0xD1, 0xD3, 0x67,
    0x9E, 0xEB, 0xDB, 0xB4, 0xBD, 0xD3, 0x2C, 0x1D, 0x62, 0x4D, 0x5D, 0x12, 0x93, 0xFB, 0xA7, 0x1B,
    0xE2, 0x64, 0xA0, 0x67, 0x74, 0x25, 0x8F, 0xD2, 0x57, 0x38, 0x0C, 0x1A, 0x44, 0xB2, 0xE1, 0x52,
    0x2F, 0xF4, 0x5E, 0xCE, 0x44, 0xD8, 0x71, 0x70, 0x07, 0x2B, 0x7A, 0xE0, 0xD6, 0x7B, 0x24, 0xA6,
    0x3A, 0x8A, 0x3F, 0x8D, 0x9E, 0x0B, 0xB6, 0x44, 0x10, 0xCC, 0xBA, 0xDB, 0x24, 0x8E, 0xFC, 0x1C,
    0x3C, 0x30, 0x30, 0xD0, 0x16, 0x33, 0xAC, 0x2D, 0x7C, 0xBB, 0x19, 0x77, 0x26, 0xD6, 0xE6, 0x29,
    0x24, 0xC6, 0xEC, 0xFB, 0x74, 0x18, 0x2B, 0x6B, 0x30, 0xD7, 0x3D, 0x02, 0x9B, 0x58, 0xEA, 0x47,
    0x5A, 0x68, 0x3F, 0xD1, 0x7E, 0x18, 0x55, 0x19, 0xF5, 0xFA, 0x99, 0x4C, 0x82, 0xD8, 0xAE, 0xA3,
    0xEC, 0x6C, 0xF9, 0x3C, 0x77, 0x45, 0xE7, 0xDE, 0x5C, 0x7D, 0xC1, 0x5B, 0x73, 0x5C, 0x62, 0x87
  },
  { /* Public Exponent - e */
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x00,
    0x00, 0x00, 0x00, 0x00, 0x00, 0x00, 0x00, 0x00, 0x00, 0x00, 0x00, 0x00, 0x00, 0x00, 0x00, 0x01
  },
  { /* Private Exponent - d */
    0x04, 0xD0, 0xAC, 0x40, 0xD6, 0xE6, 0xAF, 0x27, 0xE8, 0x33, 0x43, 0x95, 0x66, 0xD7, 0x0B, 0x90,
    0x69, 0x41, 0xCA, 0xD5, 0x33, 0x4F, 0xC6, 0xD6, 0x9A, 0x18, 0x1F, 0x77, 0x92, 0xC1, 0x52, 0x98,
    0x08, 0xDD, 0x27, 0x6A, 0x54, 0xBB, 0x17, 0xBA, 0xD3, 0x34, 0x24, 0x15, 0x53, 0x5E, 0x87, 0x6C,
    0x56, 0xC9, 0x1B, 0xBA, 0xEB, 0x80, 0x96, 0xEB, 0x6D, 0x19, 0xF2, 0x82, 0x35, 0xC6, 0x2D, 0xDE,
    0x75, 0x48, 0xB4, 0xAB, 0x6E, 0x06, 0xFD, 0x99, 0x3E, 0xC2, 0x0A, 0x80, 0x00, 0xE5, 0xF0, 0x84,
    0xB5, 0xC5, 0x1D, 0x97, 0x31, 0x94, 0x87, 0x62, 0x07, 0x1B, 0xED, 0xD6, 0x19, 0x0C, 0xF6, 0xA7,
    0x34, 0xE5, 0xA1, 0xAF, 0x94, 0xF9, 0xD5, 0xCB, 0xFF, 0xF4, 0x61, 0x65, 0x90, 0x32, 0x0A, 0x2A,
    0x5F, 0x06, 0x65, 0x01, 0x40, 0x03, 0x04, 0x1E, 0x8E, 0x9C, 0x08, 0x7C, 0xA9, 0xD5, 0x8C, 0x54,
    0x8D, 0x8C, 0x1B, 0x64, 0x9D, 0xD1, 0x0F, 0xEC, 0xD7, 0x08, 0x49, 0xD8, 0x08, 0x78, 0x50, 0x58,
    0xC1, 0xE7, 0x70, 0xE4, 0xA4, 0x39, 0x82, 0x73, 0x30, 0x43, 0x53, 0xA6, 0x12, 0x35, 0x69, 0xB9,
    0xB8, 0x6B, 0xBF, 0x97, 0x2D, 0xE0, 0x5F, 0x20, 0xBF, 0x3A, 0xF4, 0xBE, 0x5F, 0xBB, 0xC8, 0xDD,
    0x5D, 0xC9, 0xB5, 0x2F, 0x05, 0xDB, 0xB4, 0xFF, 0xF0, 0xBE, 0x2E, 0xE2, 0x6E, 0x4D, 0xD7, 0x9A,
    0x00, 0x79, 0xBB, 0xF9, 0xD8, 0xB7, 0x84, 0x94, 0x80, 0x1A, 0xC1, 0x46, 0xCE, 0x52, 0x76, 0xFF,
    0xBF, 0xC2, 0x88, 0xB2, 0x06, 0x95, 0xB4, 0x55, 0x3D, 0xD2, 0x2A, 0xB2, 0x15, 0x46, 0x3B, 0x36,
    0xD8, 0x06, 0xA0, 0x54, 0x9D, 0x89, 0x70, 0xF1, 0x07, 0x61, 0x48, 0x27, 0xE6, 0x01, 0xEE, 0x31,
    0xCA, 0xE4, 0xBB, 0xFB, 0x41, 0xC0, 0x56, 0x0C, 0x05, 0xBA, 0xB2, 0x9A, 0x22, 0xAD, 0x33, 0xB1
  },
{
  { /* Prime Factor - p */
    0xE6, 0x2B, 0x97, 0x49, 0xD9, 0xED, 0xAE, 0x85, 0x4B, 0xC1, 0xE0, 0x14, 0x4D, 0x41, 0x8B, 0xE1,
    0xA3, 0x50, 0x4E, 0xC6, 0xAB, 0x46, 0xA1, 0x5C, 0x72, 0xD3, 0x25, 0x6D, 0x77, 0xA4, 0x12, 0x94,
    0x48, 0x8D, 0x35, 0x95, 0xAA, 0x64, 0x8B, 0x40, 0x5E, 0x45, 0x49, 0x98, 0x4A, 0x6C, 0xC8, 0xBF,
    0x90, 0x4C, 0xBA, 0xED, 0x85, 0xA2, 0xF2, 0x42, 0xD5, 0xB5, 0xDE, 0x06, 0xCB, 0x80, 0x98, 0x61,
    0x50, 0x1D, 0x0E, 0x7B, 0xB9, 0xA7, 0x25, 0xD6, 0x03, 0x16, 0x9B, 0x88, 0x13, 0x1B, 0xA1, 0x01,
    0xB6, 0xD4, 0x5C, 0x39, 0xCF, 0xDA, 0x4E, 0xA2, 0x8B, 0x1C, 0xE8, 0x47, 0x98, 0x45, 0x4A, 0x7D,
    0xA8, 0xE9, 0x65, 0x11, 0xBF, 0x47, 0x57, 0x9D, 0xAA, 0x7F, 0xCD, 0xE2, 0x1C, 0x7F, 0x95, 0xE7,
    0x9F, 0x20, 0x0F, 0x43, 0x8A, 0x86, 0x10, 0x50, 0xCE, 0x77, 0xD8, 0x7C, 0x43, 0xA2, 0xEE, 0x23
  },
  { /* Prime Factor - q */
    0xD8, 0xEC, 0x6B, 0x8A, 0xA8, 0xC5, 0xE3, 0x2F, 0xD3, 0xE9, 0xF7, 0x16, 0x97, 0xAE, 0x44, 0xD3,
    0xFF, 0x20, 0x88, 0xAC, 0xF2, 0xEE, 0xF6, 0x93, 0xD7, 0x56, 0xAC, 0xDC, 0x9B, 0x24, 0x55, 0xFF,
    0xB3, 0x46, 0x3F, 0xDB, 0xA7, 0x7F, 0x72, 0xD3, 0x33, 0xDD, 0x05, 0x16, 0x79, 0x5C, 0x6C, 0xCE,
    0x83, 0x25, 0xF2, 0xA1, 0x83, 0x40, 0x20, 0x25, 0x07, 0x7D, 0x72, 0xB9, 0x94, 0x2F, 0xF2, 0x78,
    0x24, 0x20, 0x5A, 0x67, 0xDF, 0x05, 0xD5, 0x21, 0xE3, 0x73, 0x8A, 0xA9, 0x35, 0x12, 0xB7, 0x09,
    0xE1, 0x67, 0x42, 0x81, 0xD5, 0xA6, 0x24, 0x77, 0x4C, 0x44, 0xD9, 0x98, 0x86, 0x59, 0x7A, 0xE9,
    0x24, 0x21, 0x72, 0xC2, 0x9D, 0x43, 0xC8, 0x3F, 0xCD, 0xCD, 0xC6, 0x7B, 0x76, 0x32, 0x75, 0x7F,
    0x0E, 0x8F, 0xDC, 0x5D, 0xE9, 0x55, 0x3B, 0xCE, 0xC6, 0xDE, 0x4D, 0x5E, 0x31, 0x69, 0x56, 0x4D
  }
},
  {
  { /* CRT Exponent -dp)*/
    0xA7, 0x4B, 0x33, 0xB1, 0x17, 0xD6, 0xEB, 0xAC, 0x32, 0xBD, 0xFD, 0xB2, 0x83, 0xDC, 0x8A, 0x61,
    0x3C, 0x24, 0x98, 0xBD, 0x49, 0xAC, 0x12, 0x88, 0x71, 0x65, 0x0A, 0xA5, 0x1F, 0xFA, 0x7F, 0x0E,
    0x8C, 0x15, 0x26, 0xC7, 0x5B, 0x8B, 0xAC, 0xB2, 0xE2, 0x52, 0x16, 0x05, 0xBC, 0xC2, 0x88, 0xBE,
    0xC3, 0x91, 0x21, 0xA4, 0x96, 0x27, 0x33, 0x52, 0x64, 0xA6, 0xC5, 0x73, 0xC6, 0xE1, 0xF6, 0xDF,
    0x74, 0x2D, 0x4A, 0x63, 0x9F, 0x32, 0xE0, 0x0B, 0x47, 0x3F, 0x5D, 0x58, 0x70, 0x1A, 0xFA, 0xD1,
    0x96, 0x23, 0x8F, 0xCC, 0xED, 0x48, 0x4D, 0x33, 0x53, 0x4D, 0x75, 0x7E, 0xE4, 0x2C, 0x28, 0xD2,
    0x60, 0xBD, 0x13, 0x1A, 0xED, 0x1E, 0x5B, 0x8E, 0x5B, 0x68, 0x7D, 0x2A, 0x45, 0x70, 0x6E, 0x72,
    0x65, 0x74, 0x15, 0xE4, 0x0F, 0x81, 0x15, 0xC6, 0xC5, 0xEA, 0xD1, 0xCC, 0xB0, 0x14, 0x72, 0x65
  },
  { /* CRT Exponent - dq*/
    0x51, 0x06, 0x25, 0xB9, 0x1A, 0x07, 0x28, 0x2F, 0xB2, 0x28, 0xBE, 0xD9, 0x1A, 0x78, 0xC6, 0x4E,
    0xA5, 0x09, 0xE2, 0xE3, 0x2E, 0xAE, 0x61, 0x3D, 0xA1, 0x7E, 0x47, 0x7C, 0xF3, 0x19, 0xE4, 0x61,
    0x68, 0xF6, 0x01, 0x5E, 0x2B, 0x37, 0x28, 0x8D, 0x88, 0xDE, 0xB2, 0x4A, 0xCD, 0xB3, 0xDF, 0x14,
    0x57, 0xDA, 0x31, 0xC1, 0x70, 0x43, 0xE0, 0x7D, 0xD4, 0x49, 0x60, 0x33, 0xBF, 0x0D, 0x15, 0xB5,
    0x18, 0x51, 0x59, 0x53, 0x58, 0xF3, 0x55, 0xC3, 0x9D, 0xB0, 0x87, 0x87, 0x62, 0x42, 0x86, 0x49,
    0xD3, 0x7E, 0x7D, 0x51, 0xFF, 0x9A, 0x5A, 0x1E, 0x91, 0x47, 0x5A, 0x3B, 0x65, 0x5B, 0x40, 0xD4,
    0x9A, 0x61, 0x3F, 0xFB, 0x3F, 0x40, 0x95, 0x28, 0x77, 0xD7, 0xB7, 0x9E, 0x5F, 0xEC, 0xC3, 0x04,
    0x5D, 0x4D, 0x10, 0xD3, 0xA7, 0x16, 0xE6, 0x0A, 0xFB, 0x2F, 0x07, 0x98, 0xFA, 0x3D, 0xCD, 0x35
  }
},
  { /* CRT Coefficient - pq*/
    0x18, 0xC2, 0x63, 0x25, 0x6E, 0x1C, 0xF0, 0xA2, 0xA2, 0x37, 0xB9, 0x2E, 0xE3, 0x96, 0x81, 0xB0,
    0x90, 0x85, 0x11, 0x49, 0xD9, 0xB6, 0xEA, 0xB4, 0x49, 0xEB, 0x56, 0x53, 0x34, 0x0B, 0x52, 0xF1,
    0x27, 0x95, 0x31, 0xAA, 0x36, 0x47, 0x7B, 0x84, 0x77, 0x52, 0x20, 0x0E, 0x57, 0x73, 0x05, 0x87,
    0x81, 0xA3, 0xA3, 0xA1, 0xCB, 0xA0, 0x20, 0xDA, 0xF5, 0xEC, 0xD2, 0x73, 0x2A, 0x88, 0x9C, 0x00,
    0x95, 0x38, 0xFA, 0x9E, 0x77, 0xAF, 0x7B, 0xE0, 0xF1, 0x06, 0x44, 0x8D, 0x3A, 0x88, 0x4C, 0x34,
    0x0D, 0x3D, 0xBD, 0x6A, 0x60, 0xBC, 0x03, 0x16, 0x31, 0xFC, 0xDF, 0x15, 0x7A, 0x0C, 0x83, 0x64,
    0x4E, 0xA5, 0xD9, 0xC4, 0x2A, 0x88, 0x36, 0xF1, 0x01, 0x7B, 0x78, 0x83, 0xDD, 0xBA, 0xE8, 0x89,
    0xD5, 0x59, 0xC8, 0xF3, 0x5D, 0x29, 0x7C, 0xF8, 0x7F, 0xD3, 0x8E, 0xB6, 0x4C, 0xDF, 0x14, 0x2C
  }
}
```

In order to enhance the security of the present invention, a security key inputting system is introduced and incorporated in the present invention. It is well known that the traditional keyboard comprises a plurality of functional keys for data input. The major drawback of the keyboard is that all the functional keys are fixed at their locations. Therefore, when the user input the date through the functional keys, a person around the user is able to rear the data by memorization of the fixed location. In addition, other advanced detecting device can read the locations of the functional keys to be used, such as fingerprint detection. Therefore, it is unsafe for the user to use the traditional keyboard for data input, such as entering the PIN number from the ATM.

The security key inputting system according to the preferred embodiment of the present invention is specifically adapted for the touch screen device. It is arranged to randomly re-arranging the input characters at different touch-sensitive keys respectively, such that the input characters are alternately displayed at the touch-sensitive keys for preventing the input characters from being read by memorization of fixed location. It also can be incorporated with the touch screen device or a traditional keyboard. In addition, an activation key is assigned to be activated for randomly re-locating the input characters at the touch-sensitive keys respectively.

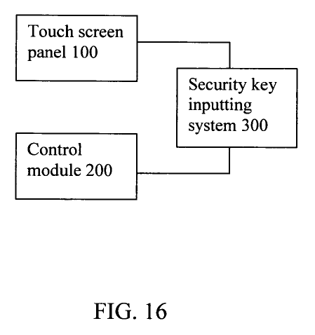

Referring to FIG. 16 of the drawings, the device of the prevent invention comprises a touch screen device, which comprises a touch screen panel 100 and a control module 200.

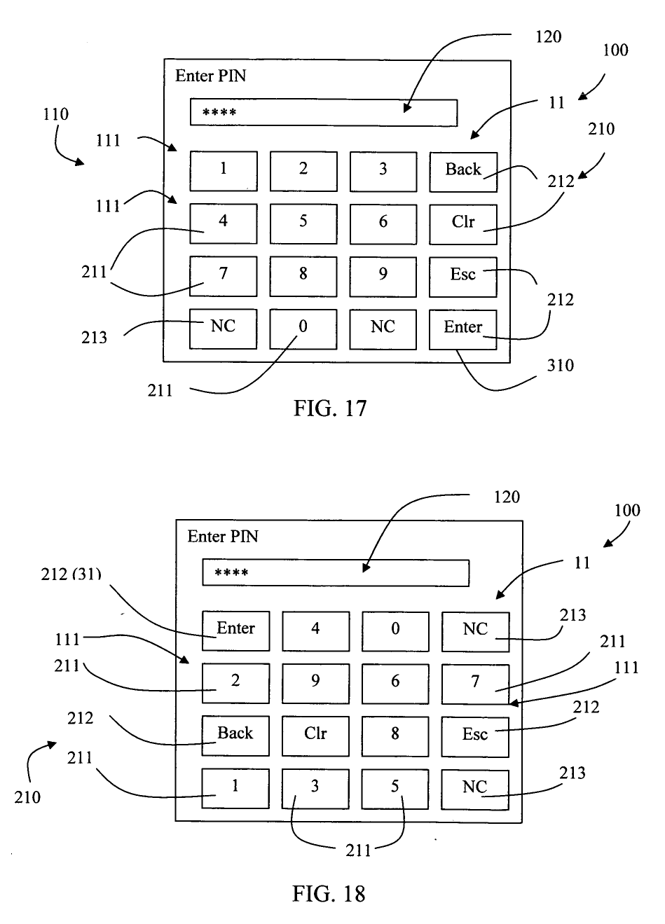

As shown in FIG. 17, the touch screen panel 100 has a key input area 110 and defining a plurality of touch-sensitive keys 111 at the key input area 110.

The control module 200 is operatively linking with the touch screen panel 100 for displaying a plurality of input characters 210 at the touch-sensitive keys 111 respectively in such a manner that when one of the touch-sensitive keys 111 is contacted, the control module 200 identifies the corresponding input character 210 being selected as an input data.

Accordingly, in order to input the corresponding input character 210, the user is able to contact the corresponding touch-sensitive key 111 by the finger tip or a touch-sensitive pen. For example, when a PIN number “1245” is needed to be input, the user is able to touch on the key input area 110 with the corresponding input characters 210 of “1”, “2”, “4”, and “5” orderly at the touch-sensitive keys 111.

As shown in FIG. 2, the input characters 210 are displayed at the touch-sensitive keys 111 respectively in a traditional manner, such that when the user inputs the PIN number, people around the user may read the PIN number by memorization of fixed location.

The present invention further provides a security key inputting system 30 to incorporate with the control module 200 to enhance the security level of the touch screen device. Accordingly, the security inputting system 300 is operatively linked between the touch screen panel 10 and the control module 200, wherein the security inputting system 30 is randomly re-arranging the input characters 210 at different touch-sensitive keys 111 respectively. Therefore, the input characters 210 are alternately displayed at the touch-sensitive keys 111 for preventing the input characters 21 from being read by memorization of fixed location.

As shown in FIG. 18, the input characters 210 are re-located at the touch-sensitive keys 111 such that when the user inputs the same PIN number, the user must contact the corresponding input characters 210 at different touch-sensitive keys 111. It is worth mentioning that the security inputting system 30 is randomly re-arranging the input characters 210 in a manner that one of the input characters 210 may re-locate at the same previous location of the touch-sensitive key 111. However, the rest of the input characters 210 will be re-located at the different locations of the touch-sensitive keys 111. In other words, the user will input the same PIN number at different locations of the touch-sensitive key 111 every time during operation.

By incorporating with the security key inputting system 300, the present invention further provides a security key inputting method for the touch screen device, comprising the following steps.

(1) Initially display the input characters 210 at the touch-sensitive keys 111 at the key input area 110 of the touch screen panel 100 respectively. Accordingly, each of the input characters 210 is displayed at the initial location of the respective touch-sensitive key 111.

(2) Periodically and randomly re-arrange the input characters 210 at different touch-sensitive keys 111 respectively.

(3) Re-locate the input characters 210 at different touch-sensitive keys 111 respectively. Therefore, the input characters 210 are alternately displayed at the touch-sensitive keys 111 for preventing the input characters 210 from being read by memorization of fixed location.

According to the preferred embodiment of the present invention, the touch screen device provides a password interface on the touch screen panel 100 for the user to input the PIN number. The input characters 210 are numerical keys 211 from 0 to 9, functional keys 212, and one or more blank keys 213. Accordingly, all the numerical keys 211, functional keys 212, and blank keys 213 are arranged to be re-located at different touch-sensitive keys 111, as shown in FIGS. 17 and 18. It is appreciated that the security key inputting system 300 is adapted to re-arrange the numerical keys 211 only, or the numerical keys 211 and the blank keys 213 only without re-locating the functional keys 212. In addition, the blank keys 213 are non-operating keys that no input data is read by the control module 200 when the blank keys 213 are contacted. However, the blank keys 213 provide more combinations for relocating the numerical keys 211 and the functional keys 212.

The security key inputting system 300 comprises an activation key 310 operatively linked with one of the input characters 210 to be displayed at one of the touch-sensitive keys 111 and arranged in such a manner that when the activation key 310 is activated by a contact of the corresponding touch-sensitive key 111, the input characters 210 are randomly re-located at the touch-sensitive keys 111 respectively. Accordingly, the period of randomly re-arranging the input characters 210 is the contact of the activation key 310.

Using the above mentioned password interface as an example, the activation key 310 is assigned as an “ENTER” key of the input character 210, such that when the “ENTER” key is contacted, all the input characters 210 are randomly re-located at the touch-sensitive keys 111 respectively.

There are two possible results for the PIN input. The first result is that when the PIN number is correctly input, the next accessing interface will be displayed on the touch screen panel 100. Therefore, once the “ENTER” key as the activation key 310 is contacted to confirm the PIN number, the input characters 210 will be re-arranged to re-locate at different touch-sensitive keys 111 on the next accessing interface on the touch screen panel 100. The second result is that when the PIN number is incorrectly input, the password interface is re-loaded for the user to re-input the PIN number. Therefore, once the “ENTER” key as the activation key 310 is contacted, the input characters 210, especially the numerical keys 211, will be re-arranged to re-locate at different touch-sensitive keys 111 on the password interface on the touch screen panel 100, as shown in FIG. 18.

As shown in FIGS. 17 and 18, the touch screen panel 100 further has a key display area 120 provided at a position adjacent to the key input area 110. The key display area 120 of the touch screen panel 100 is arranged for displaying the input characters 210 at the touch-sensitive keys 111 being contacted. For enhancing the security level, the input character 210 is converted as a hidden symbol, such as “*”, to be displayed at the key display area 120. For example, when the user touches on the key input area 110 with the four input characters 210 of “1”, “2”, “4”, and “5” orderly at the touch-sensitive keys 111, the key display area 120 will show “****” to illustrate the numbers of input characters 210 being input.

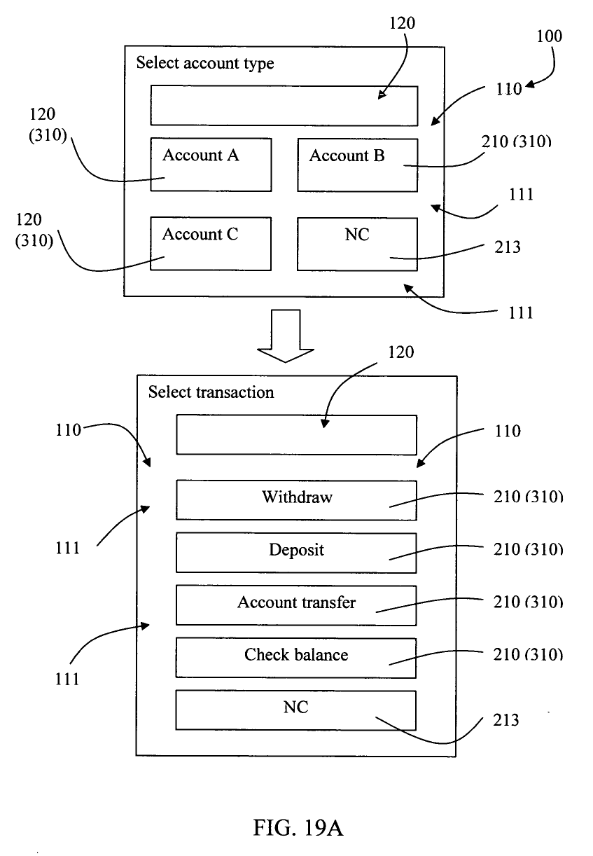

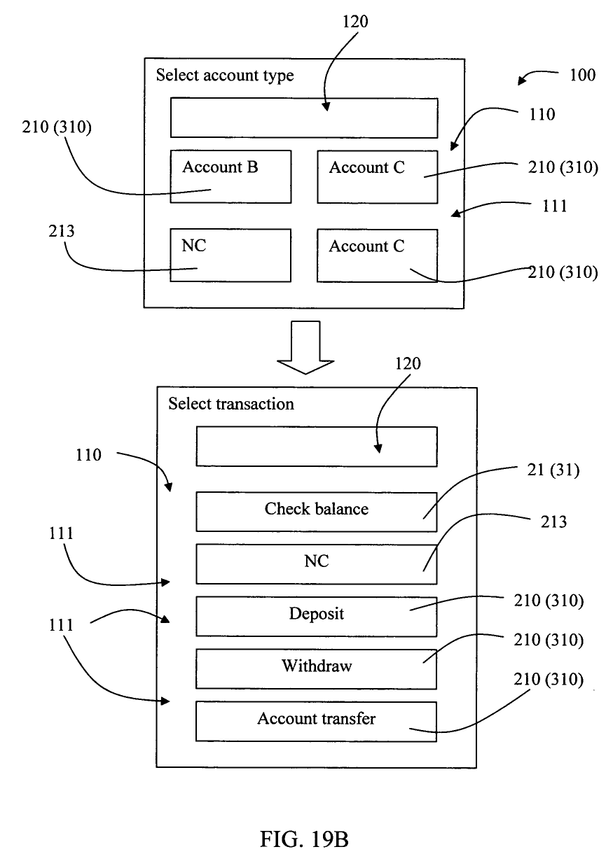

FIGS. 19A and 19B illustrates an alternative mode of the security key inputting system 300 as another example of the present invention. Accordingly, the touch screen device provides a list of option interface on the touch screen panel 100 for the user to select one of the options on the key input area 110. The input characters 210 are selection keys. As shown in FIG. 19A, the input characters 210 show different bank accounts as the selection keys for the user to select at the first option interface while the input characters 210 show different transaction options as the selection keys for the user to select at the second option interface. Accordingly, the blank keys 213 are also provided to form the combination with the selection keys. Comparing FIG. 19A with FIG. 19B, the selection keys is re-located at different touch-sensitive keys 111.

Accordingly, each of the input characters 210 displayed at the touch-sensitive keys 111 is assigned as the activation key 310, such that when one of the input characters 210 is contacted, all the input characters 210 are randomly re-located at the touch-sensitive keys 111 respectively.

Using the above mentioned option interface as an example, the activation key 310 is assigned at any one of the option keys. In other words, when the user contacts one of the bank accounts, A, B, C of the option keys, all input characters 210 are randomly re-located at the touch-sensitive keys 111 respectively at the next second option interface.

It is worth to mention that the security key inputting system 300 is adapted to incorporate with the traditional keyboard having a plurality of key buttons, wherein the input characters 210 can be re-located at different key buttons.

In order to further protect the sensitive information stored in an electronic device such as the secure financial transaction device of the present invention, the present invention embedded the self-destroy arrangement to prevent data tamper, wherein when the device is broke to get any information from a data unit of the device, a detective circuit of the device is automatically activated to erase the information saved in the data unit.

In which the detective circuit for erasing or destroying the information saved in the data unit of the electronic device is automatically activated when a resistor, a capacitor, a current, or a voltage signal is changed, so as to protect the data unit from being stolen by an external and unexpected force such as opening an outer casing or penetrating the display module to get the information of the device.

A protection layer is integrally affixed to the display module and electrically connected to the detective circuit, so that when the display module is being penetrated, the protection layer automatically activates the detective circuit to erase the information saved in the data unit. Accordingly, a plurality of conductive wires is provided to form the protection layer, wherein the conductive wires are made by a transparent material having the electrical conductivity such as ITO.

The display module comprises a liquid crystal display (LCD) and a touch screen provided at an upper surface of the LCD, so that the display module is able to communicate and control the electronic device, so as to input and output the data information. The protection layer has an area equal or larger than the area of the display module, such that the protection layer can fully cover the display module to prevent any invasion from any dead space of the display module which is non-covered by the protection layer.

A core element enclosure is provided for enclose a core circuit module of the electronic device, wherein the core element enclosure is electrically connecting to the detective circuit, such that when the core element enclosure is broke or removed from the core circuit module, the detective circuit is activated to erase the information in the data unit.

In order words, the present invention provides a method of securely data protection for the device, which comprises the steps of:

(a) enclosing a core circuit module of the electronic within a protection element to form a protection circuit surrounding the core circuit module;

(b) operatively linking a detective circuit between the protection element and the core circuit module; and

(c) activating the detective circuit in case of a hack of the electronic device, such that when the electronic device is broken to access the core circuit module through the protection element, the detective circuit is activated to block data information saved in the core circuit module from being access.

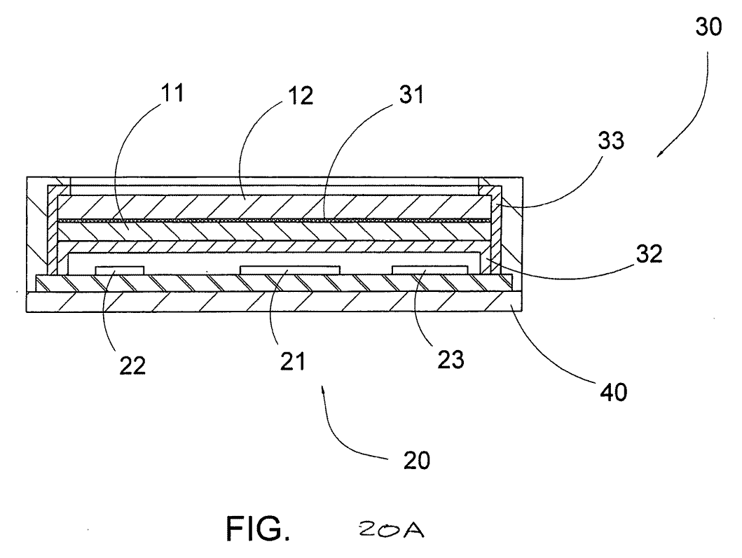

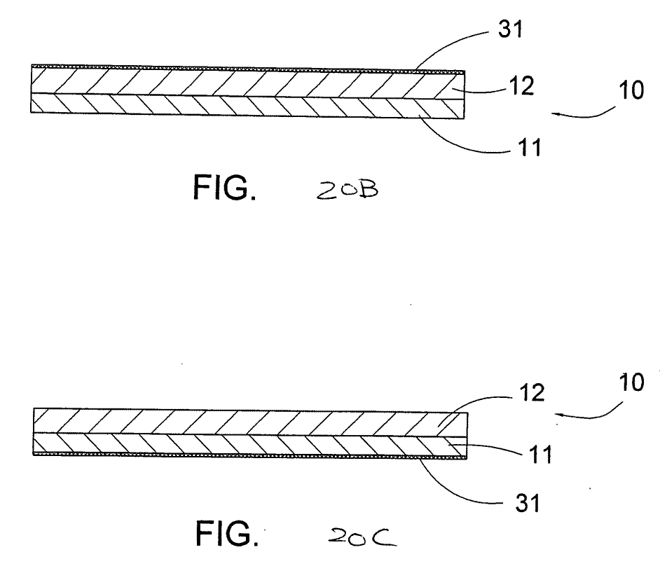

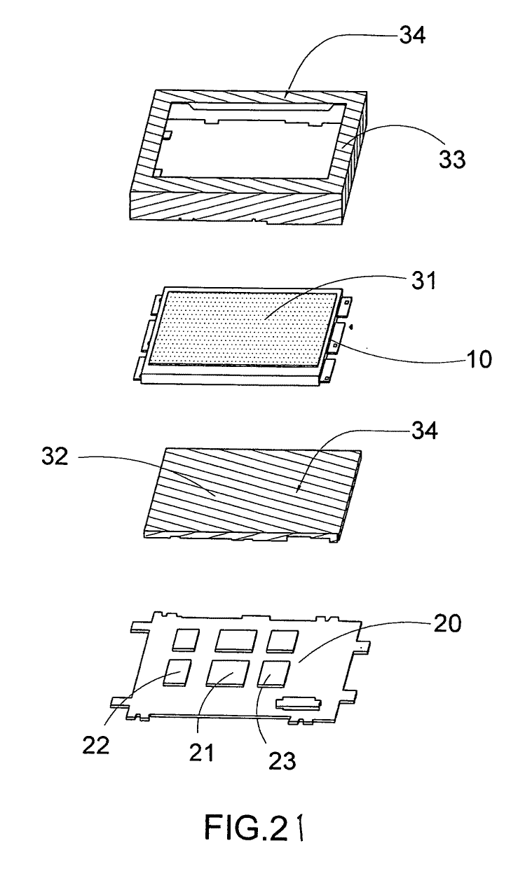

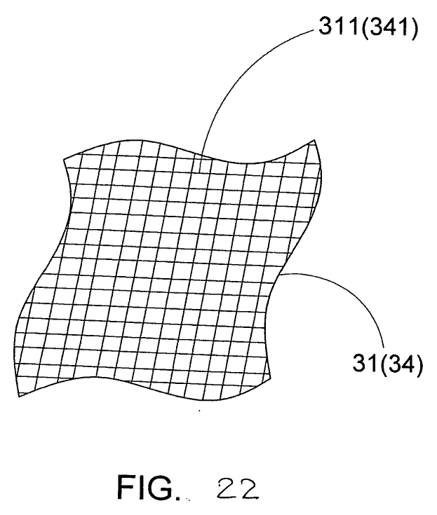

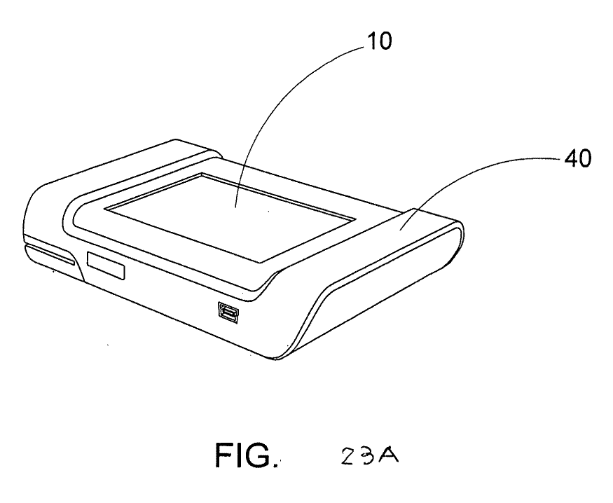

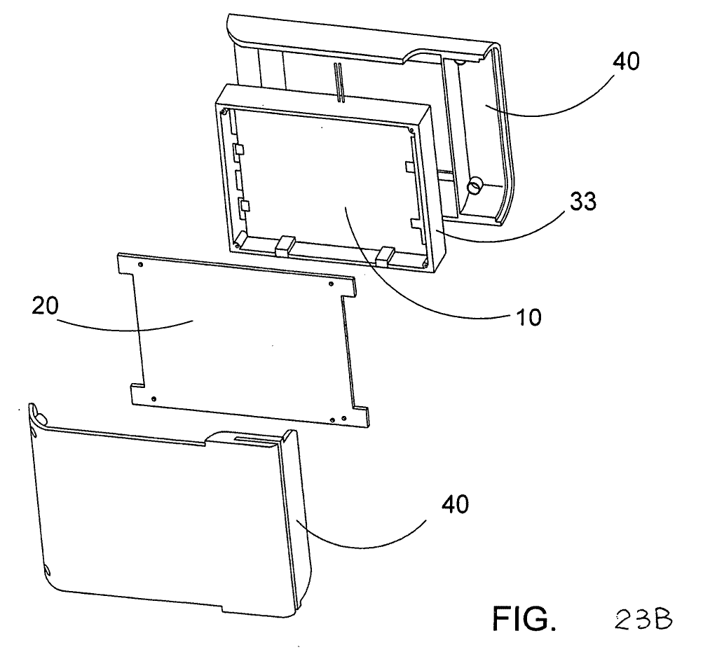

According to the preferred embodiment of the present invention, referring to FIGS. 20 to 26 of the drawings, the device according to a preferred embodiment of the present invention is illustrated, wherein the device comprises a core circuit module 20 for saving data information and a display module 10, which is embodied as the touch screen panel 100 as described above, operatively connecting to the core circuit module 20. Accordingly, the core circuit module 20 comprises a CPU 21 and a data unit 23 controllably operated by the CPU for accessing the data information.

The device further comprises a protection arrangement which comprises a protection element 30 enclosing the core circuit module 20 to form a protection circuit surrounding the core circuit module 20, and a detective circuit 22 operatively linking between the protection element 30 and the core circuit module 20, wherein when the device is broken to access the core circuit module 20 through the protection element 30 to physically interfere with the protection circuit, the detective circuit 22 is automatically activated to block data information saved in the core circuit module 20 from being access.

The protection element 30 has a protection layer 31 located above the core circuit module 20 and provided for incorporating with the display module 10, wherein the protection layer 31 of the display module 10 is electrically connecting to the core circuit module 20 of the device, so that when the display module 10 is penetrated to break into the core circuit module 20 of the device to physically interfere with the protection circuit, the protection layer 31 of the protection element 30 will activate the detective circuit 22 to destroy the data unit 23 through the CPU 21, so as to protect an data information saved in the data unit 23 from being stolen.

Accordingly, the detective circuit 22 is electrically coupled with the core circuit module 20 as one integral component, and is a data erasing circuit that when the detective circuit 22 is activated, the data information saved in the core circuit module 20 is automatically erased. The data information can be permanently erased in the core circuit module 20 or temporarily erased until a permission of access of the core circuit module 20 is obtained. Alternatively, when the detective circuit 22 is activated, the data information saved in the core circuit module 20 will be automatically frozen to prevent any access of the core circuit module 20.

The display module 10 comprises a screen panel 11 electrically connecting with the core circuit module 10 and a transparent screen 12 for covering and protecting the screen panel 11, wherein the display module 10 has a viewable area for a user to view information from the display module 10. Preferably, the transparent screen 12 of the display module 10 further has a touch screen function provided for inputting information for communicating and controlling the core circuit module 20 of the electronic device, so that the information can be conveniently inputted or/and outputted through the display module 10 and saved in the data unit 23. In order words, when the user presses to touch the display module 10, an resistor or an capacitor is changed to send an electronic signal, in such manner that the information can be inputted or/and outputted from the core circuit module 20 of the device.

It is appreciated that the transparent screen 12 having the touch screen function provided for inputting data information of the device avoids a circuit layout of conventional key board connecting to a circuit board of the electronic device, so that without the circuit layout of the conventional key board, the touch screen function of the transparent screen 12 of the display module 10 for inputting and communicating with the device increases the difficult of illegally detecting the inputting signals.

It is worth to mention that the display module 10 is a liquid crystal display (LCD), so that the display module 10 is relatively thinner, smaller, and less consuming of electricity, so as to make the electronic device to be more portable.

The protection layer 31 of the protection element 30 comprises a plurality of conductive wires 311 made by a transparent material such as ITO, intertwining to form a net shaped layer so as to form the protection circuit, wherein the conductive wires 311 of the protection layer 31 is provided to integrally incorporate the display module 10. The conductive wires 311 are integrally affixed at a lower side of the screen panel 11, or an upper side of the screen panel 12, wherein each two of the conductive wires 311 are crossed to each other to form a net shaped area to integrally affix to the lower or upper side of the screen panel 11 of the display module 10. The conductive wires 311 formed the net shaped area of the protection layer 31 is further electrically connected to the detective circuit 22, so that when the display module 10 is being penetrated to hack into the core circuit module 20 of the electronic device, the conductive wires 311 of the protection layer 31 of the protection element 30 automatically activate the detective circuit 22 of the core circuit module 20 to destroy the information being saved in the data unit 23. The conductive wires 311 of the protection layer 31 can also be provided between the screen panel 11 and the transparent screen 12, or integrally provided within the screen panel 11 or the transparent screen 12.

It is appreciated that the conductive wires 311 can also be integrally affixed to a transparent membrane, wherein the transparent membrane having the conductive wires 311 is further adhered or attached between a top surface and a bottom surface of the display module 10. In other words, the protection layer 31 is sandwiched between the screen panel 11 and the transparent screen 12 of the display module 10. Therefore, the conductive wires 311 can also be activated to connect to the detective circuit 22 when the display module 10 is being penetrated. The protection layer 31 further can be integrally provided within the screen panel 11, the transparent panel 12, between the screen panel 11 and the transparent screen 12, a bottom surface of the display module 10, or a top surface of the display module 10.

It is appreciated that the protection layer 31 can be affixed to the top surface of the transparent screen 12 of the display module 10, as shown in FIG. 20B. Likewise, the protection layer 31 can be affixed to the bottom surface of the screen panel 11 of the display module 10, as shown in FIG. 20C.

It is worth to mention that the net shaped area of the conductive wires 311 of the protection layer 31 has an area equal or larger than the viewable area of the display module 10, in such manner that the protection layer 31 can fully cover the display module 10 so as to fully protect the display module 10 being penetrated to get the information in the data unit 23 of the core circuit module 20.

It is appreciated that the protection layer 31 can also be used and affixed on any protective glasses such as car window, house window, or any different kinds of displays such as LED, LCD television, computer screen, cell phone touch screen.

The protection element 30 further comprises a core element enclosure 32 enclosing the core circuit module 20 to form a protective shield thereof, wherein the protection circuit is formed at an enclosure wall of the core element enclosure 32 for protecting the core circuit module 20 from being hacked through the core element enclosure 32.

Accordingly, the core element enclosure 32 is mounted or bonded to attach on the core circuit module 20. The protection circuit is provided on an enclosure wall of the core element enclosure 32, wherein the circuit layer 34 of the core element enclosure 32 is electrically connecting to the detective circuit 22 of the core circuit module 20, wherein when the core element enclosure 32 is being penetrated or detached from the core circuit module 20 to physically interfere with the protection circuit, the detective circuit 22 is activated to erase the data information in the data unit 23 of the core circuit module 20 of the device.

In particularly, the core element enclosure 32 comprises a circuit layer 34 overlapping at the enclosure wall to form the protection circuit and to operatively link with the detective circuit 22.

Accordingly, the core element enclosure 32 forms a cover to cover on the utilizing area of the core circuit module 20, wherein the CPU 21, the data unit 23, the detective circuit 22 are located at the utilizing area of the core circuit module 20.

The securely data protecting arrangement also comprises an auxiliary enclosure 33, wherein the auxiliary enclosure 33 has a top window coupling with a peripheral of the display module 10, and a bottom opening coupling with the core circuit module 20, so that the auxiliary enclosure 33 integrals the display module 10 and the core circuit module 20 covered by the core element enclosure 32. The auxiliary enclosure 33 has the protection circuit provided on the surface of the auxiliary enclosure 33 to form the circuit layer 34 overlapping on the surface of the auxiliary enclosure 33, wherein the circuit layer 34 is operatively linking between the auxiliary enclosure 33 and the detective circuit 22 of the core circuit module 20, so that when the auxiliary enclosure 33 is penetrated or broken to physically interfere with the protection circuit, the detective circuit 22 is automatically activated to erase or lock the data information in the data unit 23 of the core circuit module 20, in such manner that the auxiliary enclosure 33 provides a further protection of the data information.

Accordingly, in order to form the protection circuit for each of the core element enclosure 32 and the auxiliary enclosure 33, each of the core element enclosure 32 and the auxiliary enclosure 33 comprises a plurality of circuit wires 341 intertwining to form the circuit layer 34. In other words, the circuit wires 341 are provided on the enclosure wall of the core element enclosure 32 to form the circuit layer 34 thereof, while the circuit wires 341 are provided on the surface of the auxiliary enclosure 33 to form the circuit layer 34 thereof.

It is appreciated that the circuit layer 34 can be configured as the same as the protection layer 31 that the circuit wires 341 are the same as the conductive wires 311. However, since the circuit wires 341 does not require having the transparent function, the circuit wires 341 can be made of non-transparent conductive material. In addition, the circuit wires 341 can be affixed to the enclosure wall of the core element enclosure 32 and to the surface of the auxiliary enclosure 33 by adhesive. Likewise, the circuit wires 341 can be embedded into the enclosure wall of the core element enclosure 32 and into the surface of the auxiliary enclosure 33 such that each of the core element enclosure 32 and the auxiliary enclosure 33 forms the protection circuit.

It is worth mentioning that the core circuit module 20 are protected by three different protections, i.e. the protection layer 31, the core element enclosure 32, and the auxiliary enclosure 33, for preventing the core circuit module 20 from being physically hacked.

An outer casing 40 is further provided to enclose the core circuit module 20, the display module 10, the core element enclosure 32, and the auxiliary enclosure 33 in a hidden manner, wherein the outer casing 40 can not only provide a decoration for the securely data protecting arrangement, but also provide another protection of the data information of the data unit 23 of the core circuit module 20.

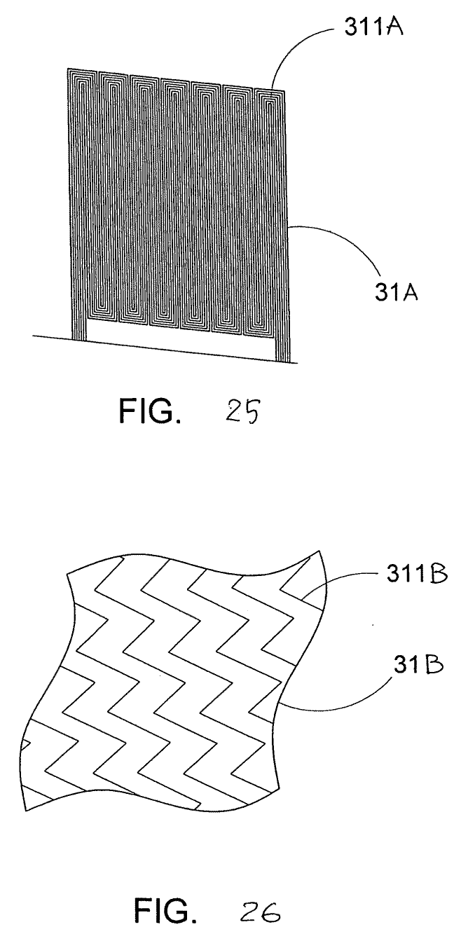

Referring to FIG. 25, a first alternative of a protection layer 31A of the display module 10 of the securely data protecting arrangement according to the above preferred embodiment of the present invention is illustrated, wherein the protection layer 31A has a plurality of conductive wires 311A. Each of the conductive wires 311A is arranged similar to a “Z” shape and any two of the conductive wires 311A are parallel to each other. In order words, each of the conductive wires 311A has a serrate shape to form a net of the protection layer 31A for covering the display module 10.

Referring to FIG. 26, a second alternative of a protection layer 31B of the display module 10 of the securely data protecting arrangement according to the above preferred embodiment of the present invention is illustrated, wherein the protection layer 31B has a conductive wire 311B continuing folded to form a continuing “S” shape to cover the display module 10.

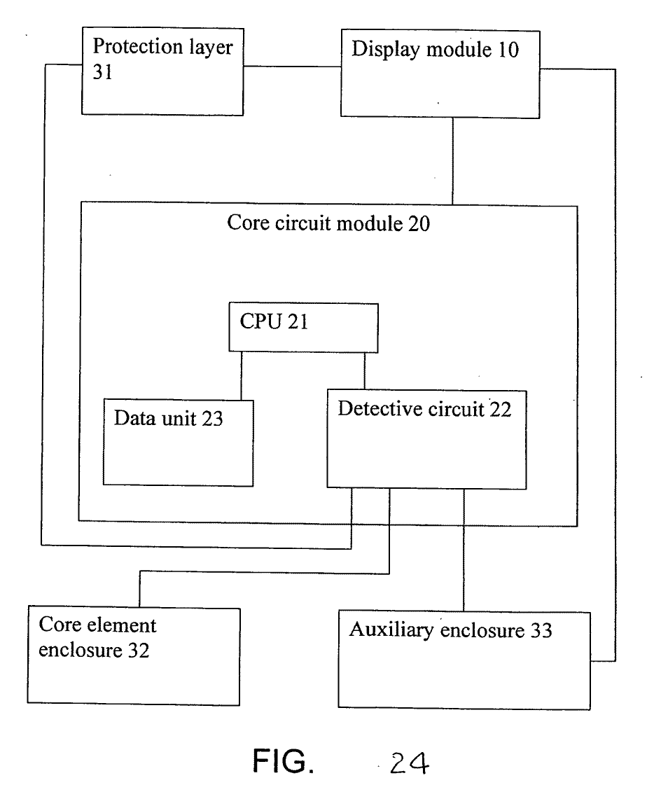

In view of above description of the device, referring to FIG. 24 of the drawings, the method of securely data protecting arrangement of such device comprises the steps of:

providing the data unit 23, the detective circuit 22, and the CPU 21 to the core circuit module 20 of the device, wherein the data unit 23, the detective circuit 22, and the CPU 21 are electrically connected to each other; and

electrically connecting the protection element 30 to the core circuit module 20 of the electronic device, so that when the electronic device is hacked to achieve the data information of the core circuit module 20, the protection circuit is physically interfered to activate the detective circuit 22 of the core circuit module 20 to erase a data information saved in the data unit 23 through the CPU 21, so as to protect the data information saved in the data unit 23 of the core circuit module 20.

The method of securely data protecting arrangement also comprises a step of coupling the auxiliary enclosure 33 of the protection element 30 to the display module 10 and the core circuit module 20.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A secure method of financial transaction, comprising the steps of:
(a) receiving transaction information and personal information of a user in a secure financial transaction device;
(b) encrypting the transaction information, the personal information and a PIN of the user in the device and transferring the encrypted transaction information, personal information and PIN to a designate financial entity through the Internet;
(c) verifying a payment amount to a designated financial account with the financial entity; and
(d) receiving a confirmation in the device for the transaction of the payment amount to the designated financial account, after the payment amount is transferred to the designated financial account from the financial entity, by the financial entity through the Internet.

2. The method, as recited in claim 1, further comprising a step of securely operating sensitive information including the transaction information, the personal information and the PIN.

3. The method, as recited in claim 2, wherein the securely operating step further comprises the steps of:
(i) storing secrete data in a secure memory wherein application program has not access, wherein the secrete data is always encrypted before being outputted.
(ii) providing a supervisor mode wherein a firmware is processed, wherein all system resources are accessible;
(iii) providing a user mode wherein user's application program is processed, wherein the application program has no access to system resources; and
(iv) providing a unified interface for application program development.

4. The method, as recited in claim 1, further comprising a key encryption method for completing a confirmation process.

5. The method, as recited in claim 4, wherein the key encryption method comprises the steps of:
partitioning a private key into a plurality of key components;
converting the key components;
after the key components are converted, exporting the key components into a plurality of key holders respectively for enhancing a security level of the private key; and
synthesizing back the private key by uniting the key components in the key holders in order for completing the confirmation process so as to ensure the confirmation process being verified by all of the key holders.

6. The method, as recited in claim 1, further comprising a security step of generating a PIN keypad randomly for generating PIN.

7. The method, as recited in claim 6, wherein the security step further comprises the steps of:
initially displaying a plurality of input characters at a plurality of touch-sensitive keys at the key input area of a touch screen panel respectively, wherein when one of the touch-sensitive keys is contacted, a control module identifies the corresponding input character being selected as an input data;
periodically and randomly re-arranging the input characters at different touch-sensitive keys respectively through a security key inputting system which is operatively linked to the control module; and
re-locating the input characters at different touch-sensitive keys respectively, wherein the input characters are alternately displayed at the touch-sensitive keys for preventing the input characters from being read by memorization of fixed location.

8. The method, as recited in claim 1, further comprising a step of blocking data information saved in the device from being tamper.

9. The method, as recited in claim 8, wherein the blocking step further comprises the steps of:
enclosing a core circuit module of the electronic device within a protection element to form a protection circuit surrounding the core circuit module;
operatively linking a detective circuit between the protection element and the core circuit module; and
activating the detective circuit in case of a hack of the electronic device, such that when the electronic device is broken to access the core circuit module through the protection element to physically interfere with the protection circuit, the detective circuit is activated to block data information saved in the core circuit module from being access.
